(19) United States
(12) Patent Application Publication
(10) Pub. No.: US 2026/0128839 A1
(43) Pub. Date: May 7, 2026

(54) COMMAND COMMUNICATION FOR ENERGY HARVESTING DEVICES

(71) Applicant: QUALCOMM Incorporated, San Diego, CA (US)

(72) Inventors: Ahmed ELSHAFIE, San Diego, CA (US); Huilin XU, Temecula, CA (US); Linhai HE, San Diego, CA (US); Seyedkianoush HOSSEINI, San Diego, CA (US); Zhikun WU, Beijing (CN); Yuchul KIM, San Diego, CA (US); Wei YANG, San Diego, CA (US)

(21) Appl. No.: 19/114,419

(22) PCT Filed: Dec. 7, 2022
(86) PCT No.: PCT/CN2022/137169

§ 371 Date: Mar. 21, 2025

(51) Int. Cl. H04L 5/00; H04W 72/23; H04W 88/04

(52) U.S. Cl. CPC H04L 5/0055; H04W 72/23; H04W 88/04

(57) ABSTRACT

A network node may generate a command intended for an energy harvesting (EH) device, and the network node may transmit information indicating the command to each user equipment (UE) of a set of UEs. The command may be associated with configuring data on the EH device. Each of the UEs may receive, from the network node, the information indicating the command intended for an EH device, and each UE may be further configured to wirelessly transmit, to the EH device, the command associated with configuring data on the EH device. An EH device may wirelessly receive the command from a UE, and the EH device may set at least one parameter of the EH device according to the command.

### BACKGROUND

### Technical Field

The present disclosure generally relates to communication systems, and more particularly, to communication of commands generated by network nodes to energy harvesting devices.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a network node or a component thereof that may be configured to generate a command intended for an energy harvesting (EH) device that is separately house from each user equipment (UE) of a set of UEs. The command may be associated with configuring data on the EH device. The apparatus may be further configured to transmit, to each UE of the set of UEs, information indicating the command with an instruction to wirelessly relay the command to the EH device.

In another aspect of the disclosure, another method, another computer-readable medium, and another apparatus are provided. The other apparatus may be a UE or a component thereof that may be configured to receive, from a network node, information indicating a command intended for an EH device, which is separately housed from the other apparatus. The other apparatus may be further configured to wirelessly transmit, to the EH device, the command associated with configuring data on the EH device.

In a third aspect of the disclosure, a third method, a third computer-readable medium, and a third apparatus are provided. The third apparatus may be an EH device or a component thereof that may be configured to wirelessly receive a command from a UE that is separately house from the third apparatus. The third apparatus may be further configured to set at least one parameter of the third apparatus according to the command.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating an example disaggregated base station architecture.

FIG. 3A is a diagram illustrating an example of a first frame, in accordance with various aspects of the present disclosure.

FIG. 3B is a diagram illustrating an example of downlink channels within a subframe, in accordance with various aspects of the present disclosure.

FIG. 3C is a diagram illustrating an example of a second frame, in accordance with various aspects of the present disclosure.

FIG. 3D is a diagram illustrating an example of uplink channels within a subframe, in accordance with various aspects of the present disclosure.

FIG. 4 is a diagram illustrating an example of a base station and user equipment (UE) in an access network.

FIG. 5 is a block diagram illustrating an example of backscatter communication between an energy harvesting (EH) device and a radio frequency identification (RFID) reader in an RFID system.

FIG. 6 is a block diagram illustrating another example of an EH device.

FIG. 7 is a block diagram illustrating still another example of an EH device.

FIG. 8 is a block diagram illustrating examples states of a modulator configured in an EH device.

FIG. 9 is a block diagram illustrating example signalling communicated between an RFID reader and an EH device.

FIG. 10 is a block diagram illustrating an example wireless communications system in which a set of UEs is configured to relay a command to an EH device from a network node.

FIG. 11 is a timing diagram illustrating an example of wireless communication between an RFID reader and an EH device.

FIG. 12 is a call flow diagram illustrating example communication of a command generated by a network node to an EH device via a set of UEs.

FIG. 13 is a call flow diagram of an example of feedback provided by an EH device for a command generated by a network node.

FIG. 14 is a flowchart illustrating an example of a method of wireless communication at a UE.

FIG. 15 is a flowchart illustrating an example of a method of wireless communication at a network node.

FIG. 16 is a flowchart illustrating an example of a method of wireless communication at an EH device.

FIG. 17 is a diagram illustrating an example of a hardware implementation for an example apparatus.

FIG. 18 is a diagram illustrating another example of a hardware implementation for another example apparatus.

FIG. 19 is a diagram illustrating still another example of a hardware implementation for still another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, the concepts and related aspects described in the present disclosure may be implemented in the absence of some or all of such specific details. In some instances, well-known structures, components, and the like are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, computer-executable code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or computer-executable code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer-executable code in the form of instructions or data structures that can be accessed by a computer.

As referenced in the present disclosure, radio-frequency identification (RFID) is a technology that employs radio frequency (RF) waves to communicate relatively small amounts of information, typically between a reader and an energy harvesting (EH) device, such as an RFID tag. Illustratively, an RFID reader may issue an interrogatory pulse to an EH device and, in response, the EH device transmits some digital data, which often includes some uniquely identifying information about the EH device.

EH devices may be implemented as standalone devices or integrated into another device, such as a UE. For example, in some implementations, an EH device may be or may include an RFID tag. In some other implementations, an EH device may be or may be included in a user equipment (UE), such as a UE that uses a specific radio (e.g., an RFID tag radio) during some low power mode(s), when the power supply is depleted, and/or when configured to conserve power (e.g., where the UE is operating in a sleep state). Other example implementations of EH devices include zero-power (ZP) Internet of Things (IoT) (ZP-IoT) devices, ambient IoT devices, and passive IoT (P-IoT) devices, as described infra.

Different RFID systems may implement different EH devices, such as active EH devices, passive EH devices, or semi-passive EH devices. Active EH devices may include individual power supplies (e.g., a batteries), allowing for greater transmission ranges, periodicities, etc. than passive and semi-passive EH devices. For example, an active EH device may periodically transmit data, such as an identifier (ID) uniquely identifying the EH device within an RFID system.

Passive EH devices lack onboard power supplies; rather, a passive EH device is powered via radio energy obtained via an RFID reader of the RFID system. Consequently, electromagnetic interrogation by the RFID reader is a necessary (and sufficient) condition for wirelessly reading digital data from a passive EH device. In the absence of such a power supply, passive EH devices may consume relatively minor amounts of power, e.g., less than approximately 100 microwatts (u W).

Semi-passive EH devices (also referred to as semi-active or battery-assisted EH devices) combine some characteristics of active and passive EH devices. In particular, a semi-passive EH device may include an individual power supply (e.g., battery), but may not be configured to wirelessly transmit digital data in the absence of an RFID reader. For example, the power supply of a semi-passive EH device may be activated when illuminated by an RFID reader of its RFID system, and the semi-passive EH device may resultingly transmit data stored thereon.

While RFID as a communication technology may be employed in individual RFID systems, an industry and/or widely accepted standard that facilitates device interoperability, applicability, etc. has yet to be adopted. However, RFID may be usefully integrated and employed via a telecommunication standard, such as 5G New Radio (NR) and/or other communication standard promulgated by Third Generation Partnership Project (3GPP).

Accordingly, 3GPP may implement RFID in a standard release, such as in relation to the IoT. For example, the 5G System (5GS) may be extended to define some energy-harvesting enabled communication services (EHECS). EHECS may include RFID systems in which EH devices lack batteries or include relatively limited energy storage (e.g., via a capacitor). To that end, ZP communication may be implemented in the 5GS, which may include ZP-IoT. In some aspects of the present disclosure, an EH device may be implemented as a P-IoT device and/or a ZP-IoT device, such as a device having zero maintenance energy storage (or minimal energy storage), which may include a device lacking a battery and/or wired connection to a power supply but having at least one capacitor (or supercapacitor) that is charged via RF energy harvesting modules. The energy harvested from RF waves received from a transmitter may be sufficient to supply power to a microcontroller of a ZP-IoT device for a duration sufficient to execute one more processor cycles. Such ZP-IoT devices may be cost effective to manufacture and may allow for smaller form factors (e.g., relative to devices having batteries). In some aspects, a ZP-IoT device and/or a P-IoT device may be implemented as an RFID tag having no or limited energy storage unit (e.g., a battery). An energy storage unit of such an implementation of a ZP-IoT and/or P-IoT device may be fully or partially charged via one or more energy harvesting techniques. ZP-IoT and P-IoT devices may be or may include RFID tags, modems (e.g., including some legacy modems), sensors, and/or other device (e.g., wearables and/or other smart technology) that uses energy harvesting techniques to obtain ambient energy to fully or partially supply power to some or all components. In addition to RF energy, other energy harvesting techniques may be implemented to obtain energy through thermal radiation, solar radiation, lasers, and/or other sources. that partially rely on energy harvesting techniques (e.g., solar, RF, thermal, laser, etc.)/Also, mention that the focus here is related to RFID tag or when ZP-IoT/P-IoT is an RFID tag. This tag can have limited energy storage unit/battery which is partially or fully charged based on EH, etc.

A wide variety of issues may warrant addressing in order for RFID and EH devices to be broadly adopted into the 5GS, such as service requirements, key performance indicators (KPIs) (e.g., data rates, power densities, etc.), onboarding and provisioning, decommissioning, identification, authentication and authorization, access control, mobility management, security, and so forth. The standardization of various mechanisms and approaches to such issues may evolve at a rate at which replacing EH devices may be infeasible. Thus, an approach to configuring EH devices to adhere to a communication standard may be beneficial in terms of scalability, cost efficiency, and the like.

Various aspects relate generally to configuring EH devices. Some aspects more specifically relate to communication of commands generated by network nodes to EH devices. Some further aspects more specifically relate to relay of such commands from network nodes to EH devices through UEs. In some examples, a network node may generate a command intended for an EH device. For example, the network node may generate a command to set a value of a parameter stored in memory of the EH device, such as a command to add a value of a new parameter, a command to delete a value of a parameter, or a command to adjust a value of a parameter. The network node may transmit the generated command to a set of UEs, and the UEs may be configured to relay the command to the EH device. In some examples, a UE may supply power to the EH device, e.g., through radio frequency (RF) waves. The EH device may receive the command via at least one of the set of UEs and, based thereon, the EH device may set a parameter indicated by the command to the value indicated by the command. In some further examples, the EH device may transmit information acknowledging the command to one or more of the set of UEs. The set of UEs may cease transmitting the command to the EH device based on the information acknowledging the command, and/or one or more of the set of UEs may transmit relay the information acknowledging the command to the network node.

Particular aspects of the subject matter described in this disclosure can be implemented to realize one or more of the following potential advantages. In some examples, the techniques described herein may be used by a network to issue commands that configure passive EH devices. Configuration of EH devices via network-issued commands may broaden the scope of use cases in which passive EH devices and ZP-IoT devices may be practically implemented. In some other examples, the techniques described herein may be used to dynamically set values of parameters stored by EH devices, which is in contrast to conventional EH devices having parameters that are statically configured with immutable values. By dynamically setting parameter values, deprecation and/or obsolescence of EH devices may be avoided when parameters values become stale, inaccurate, compromised, etc. Such avoidance may be beneficial with regard to economic costs, environmental impact, implementation schedule, and so forth. In still further examples, the techniques described herein may be used to relay network-issued commands to EH devices via one or more UEs. As UEs are generally ubiquitous, EH devices may be deployed in a number of diverse environments in which UEs may be relied upon to supply power and relay commands to EH devices.

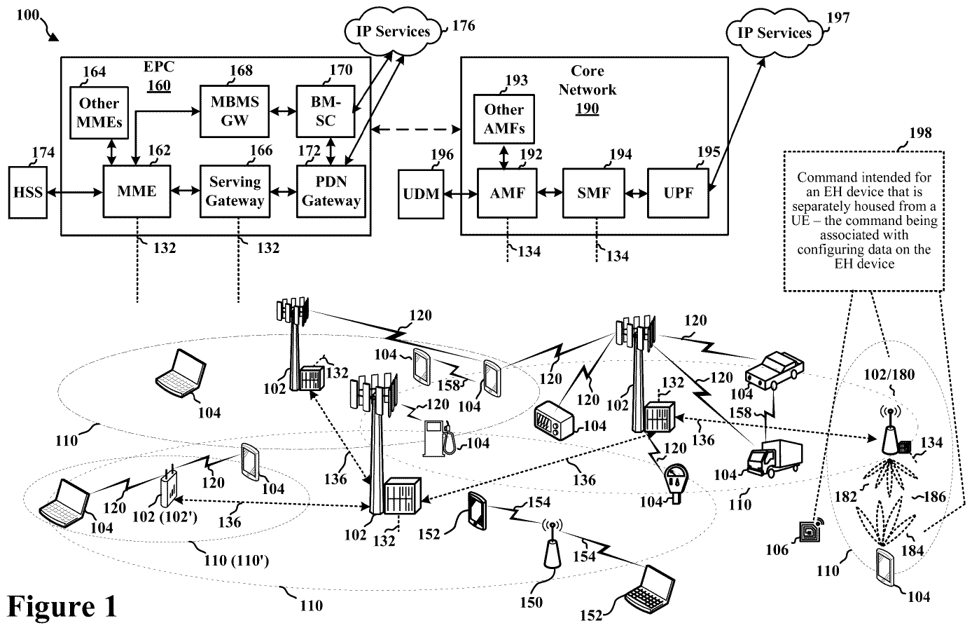

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells, such as high power cellular base stations, and/or small cells, such as low power cellular base stations (including femtocells, picocells, and microcells).

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR, which may be collectively referred to as the Next Generation Radio Access Network (RAN) (NG-RAN), may interface with a core network 190 through second backhaul links 134. In addition to other functions, the base stations 102 may perform one or more of: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, Multimedia Broadcast Multicast Service (MBMS), subscriber and equipment trace, RAN information management (RIM), paging, positioning, and delivery of warning messages.

In some aspects, the base stations 102 may communicate directly or indirectly (e.g., through the EPC 160 or core network 190) with each other over third backhaul links 136 (e.g., X2 interface). The first backhaul links 132, the second backhaul links 134, and the third backhaul links 136 may be wired, wireless, or some combination thereof. At least some of the base stations 102 may be configured for integrated access and backhaul (IAB). Accordingly, such base stations may wirelessly communicate with other base stations, which also may be configured for IAB.

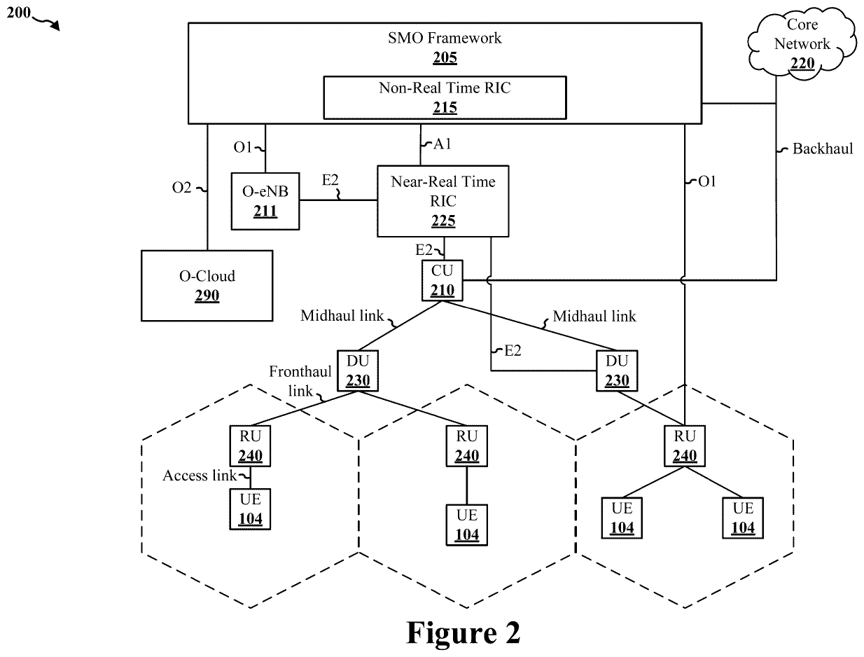

At least some of the base stations 102 configured for IAB may have a split architecture including multiple units, some or all of which may be collocated or distributed and which may communicate with one another. For example, FIG. 2, infra, illustrates an example disaggregated base station 200 architecture that includes at least one of a central unit (CU) 210, a distributed unit (DU) 230, a radio unit (RU) 240, a remote radio head (RRH), a remote unit, and/or another similar unit configured to implement one or more layers of a radio protocol stack.

The base stations 102 may wirelessly communicate with the UEs 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.).

A UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Each of the base stations 102 may provide communication coverage for a respective geographic coverage area 110, which may also be referred to as a “cell.” Potentially, two or more geographic coverage areas 110 may at least partially overlap with one another, or one of the geographic coverage areas 110 may contain another of the geographic coverage areas. For example, the small cell 102′ may have a coverage area 110′ that overlaps with the coverage area 110 of one or more macro base stations 102. A network that includes both small cells and macrocells may be known as a heterogeneous network. A heterogeneous network may also include Home Evolved Node Bs (eNBs) (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use multiple-input and multiple-output (MIMO) antenna technology, including spatial multiplexing, beamforming, and/or transmit diversity. Wireless links or radio links may be on one or more carriers, or component carriers (CCs). The base stations 102 and/or UEs 104 may use spectrum up to Y megahertz (MHz) (e.g., Y may be equal to or approximately equal to 5, 10, 15, 20, 100, 400, etc.) bandwidth per carrier allocated in a carrier aggregation of up to a total of Yx MHz (e.g., x CCs) used for transmission in each direction. The CCs may or may not be adjacent to each other. Allocation of CCs may be asymmetric with respect to downlink and uplink (e.g., more or fewer CCs may be allocated for downlink than for uplink).

The CCs may include a primary CC and one or more secondary CCs. A primary CC may be referred to as a primary cell (PCell) and each secondary CC may be referred to as a secondary cell (SCell). The PCell may also be referred to as a “serving cell” when the UE is known both to a base station at the access network level and to at least one core network entity (e.g., AMF and/or MME) at the core network level, and the UE may be configured to receive downlink control information in the access network, such as where the UE is in a radio resource control (RRC) Connected state. In some instances in which carrier aggregation is configured for the UE, each of the PCell and the one or more SCells may be a serving cell.

Certain UEs 104 may communicate with each other using device-to-device (D2D) communication link 158. The D2D communication link 158 may use the downlink/uplink WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (or “mmWave” or simply “mmW”) band in documents and articles, despite being different from the extremely high frequency (EHF) band (30 GHZ-300 GHz) which is identified by the International Telecommunications Union (ITU) as a “millimeter wave” band. In some aspects, “mmW” or “near-mmW” may additionally or alternatively refer to a 60 GHz frequency range, which may include multiple channels outside of 60 GHz. For example, a 60 GHz frequency band may refer to a set of channels spanning from 57.24 GHz to 70.2 GHz.

In view of the foregoing, unless specifically stated otherwise, the term “sub-6 GHz,” “sub-7 GHZ,” and the like, to the extent used herein, may broadly represent frequencies that may be less than 6 GHZ, frequencies that may be less than 7 GHZ, frequencies that may be within FR1, and/or frequencies that may include mid-band frequencies. Further, unless specifically stated otherwise, the term “millimeter wave” and other similar references, to the extent used herein, may broadly represent frequencies that may include mid-band frequencies, frequencies that may be within FR2, and/or frequencies that may be within the EHF band.

A base station 102 may be implemented as a macro base station providing a large cell or may be implemented as a small cell 102′ having a small cell coverage area. Some base stations 102 may operate in a traditional sub-6 GHz (or sub-7 GHZ) spectrum, in mmW frequencies, and/or near-mmW frequencies in communication with the UE 104. When such a base station operates in mmW or near-mmW frequencies, the base station may be referred to as a mmW base station 180. The mmW base station 180 may utilize beamforming 186 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182. The UE 104 may receive the beamformed signal from the base station 180 in one or more receive directions 184. The UE 104 may also transmit a beamformed signal to the base station 180 in one or more transmit directions. The base station 180 may receive the beamformed signal from the UE 104 in one or more receive directions. One or both of the base station 180 and/or the UE 104 may perform beam training to determine the best receive and/or transmit directions for the one or both of the base station 180 and/or UE 104. The transmit and receive directions for the base station 180 may or may not be the same. The transmit and receive directions for the UE 104 may or may not be the same.

In various different aspects, one or more of the base stations 102/180 may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology.

In some aspects, one or more of the base stations 102/180 may be connected to the EPC 160 and may provide respective access points to the EPC 160 for one or more of the UEs 104. The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, with the Serving Gateway 166 being connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a Packet Switch (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

In some other aspects, one or more of the base stations 102/180 may be connected to the core network 190 and may provide respective access points to the core network 190 for one or more of the UEs 104. The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a PS Streaming Service, and/or other IP services.

In certain aspects, a base station 102/180 may be configured to generate a command 198 intended for an EH device 106 that is separately house from each UE 104 of a set of UEs. The command 198 may be associated with configuring data on the EH device 106. The base station 102/180 may transmit, to each UE 104 of the set of UEs, information indicating the command 198 with an instruction to wirelessly relay the command to the EH device 106.

Correspondingly, a UE 104 may be configured to receive, from the base station 102/180, information indicating the command 198 intended for the EH device 106, which is separately housed from the UE 104. The UE 104 may be further configured to wirelessly transmit, to the EH device 106, the command 198 associated with configuring data on the EH device 106.

Accordingly, the EH device 106 may be configured to wirelessly receive the command 198 from the UE 104 that is separately house from the EH device 106. The EH device 106 may be further configured to set at least one parameter of the EH device 106 according to the command 198.

Further details and aspects related to communicating a command to an EH device are described herein.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

FIG. 2 shows a diagram illustrating an example disaggregated base station 200 architecture. Deployment of communication systems, such as 5G NR systems, may be arranged in multiple manners with various components or constituent parts. In a 5G NR system, or network, a network node, a network entity, a mobility element of a network, a RAN) node, a core network node, a network element, or a network equipment, such as a base station, or one or more units (or one or more components) performing base station functionality, may be implemented in an aggregated or disaggregated architecture. For example, a base station (or network node) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 200 architecture may include one or more CUs 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links. In some implementations, the UE 104 may be simultaneously served by multiple RUs 240.

Each of the units, i.e., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 210 may host one or more higher layer control functions. Such control functions can include RRC, packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-CNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an AI interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

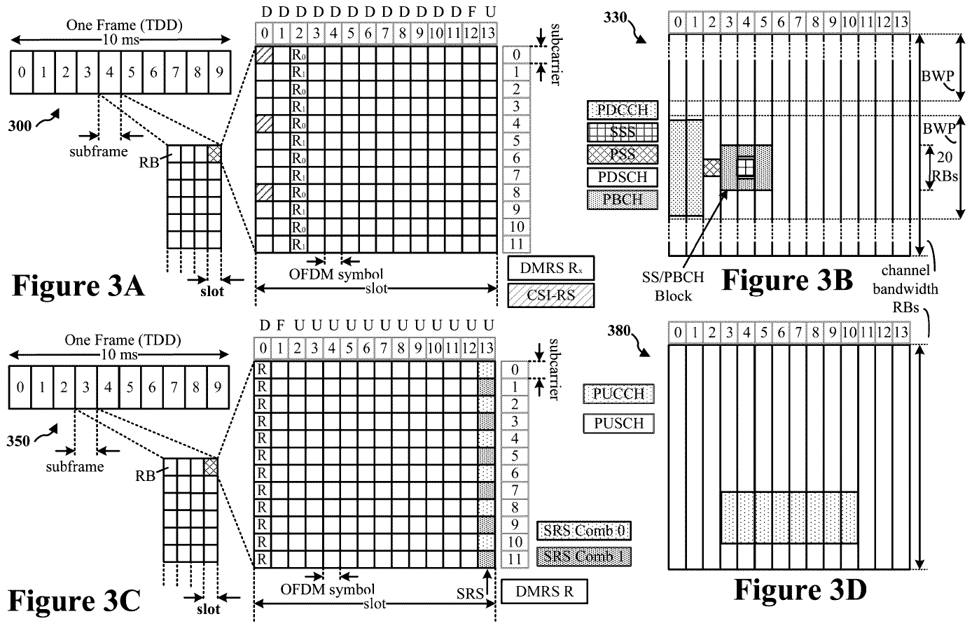

FIG. 3A is a diagram illustrating an example of a first subframe 300 within a 5G NR frame structure. FIG. 3B is a diagram illustrating an example of downlink channels within a 5G NR subframe 330. FIG. 3C is a diagram illustrating an example of a second subframe 350 within a 5G NR frame structure. FIG. 3D is a diagram illustrating an example of uplink channels within a 5G NR subframe 380. The 5G NR frame structure may be frequency division duplexed (FDD) in which for a particular set of subcarriers (carrier system bandwidth), subframes within the set of subcarriers are dedicated for either downlink or uplink, or may be time division duplexed (TDD) in which for a particular set of subcarriers (carrier system bandwidth), subframes within the set of subcarriers are dedicated for both downlink and uplink. In the examples provided by FIGS. 3A and 3C, the 5G NR frame structure is assumed to be TDD, with subframe 4 being configured with slot format 28 (with mostly downlink), where D is downlink, U is uplink, and F is flexible for use between downlink/uplink, and subframe 3 being configured with slot format 34 (with mostly uplink). While subframes 3, 4 are shown with slot formats 34, 28, respectively, any particular subframe may be configured with any of the various available slot formats 0-61. Slot formats 0, 1 are all downlink, uplink, respectively. Other slot formats 2-61 include a mix of downlink, uplink, and flexible symbols. UEs are configured with the slot format (dynamically through downlink control information (DCI), or semi-statically/statically through RRC signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on downlink may be cyclic prefix (CP) orthogonal frequency-division multiplexing (OFDM) (CP-OFDM) symbols. The symbols on uplink may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2ª *15 kilohertz (kHz), where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs). Within a set of frames, there may be one or more different bandwidth parts (BWPs) (see FIG. 3B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry at least one pilot signal, such as a reference signal (RS), for the UE. Broadly, RSs may be used for beam training and management, tracking and positioning, channel estimation, and/or other such purposes. In some configurations, an RS may include at least one demodulation RS (DM-RS) (indicated as Rx for one particular configuration, where 100x is the port number, but other DM-RS configurations are possible) and/or at least one channel state information (CSI) RS (CSI-RS) for channel estimation at the UE. In some other configurations, an RS may additionally or alternatively include at least one beam measurement (or management) RS (BRS), at least one beam refinement RS (BRRS), and/or at least one phase tracking RS (PT-RS).

FIG. 3B illustrates an example of various downlink channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. A UE (such as a UE 104 of FIG. 1) may use the PSS to determine subframe/symbol timing and a physical layer identity. A secondary synchronization signal (SSS) may be within symbol 4 of particular subframes of a frame. A UE (such as a UE 104 of FIG. 1) may use the SSS to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the uplink.

FIG. 3D illustrates an example of various uplink channels within a subframe of a frame. The PUCCH may be located as indicated in one configuration. The PUCCH carries uplink control information (UCI), which may include a scheduling request (SR), a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

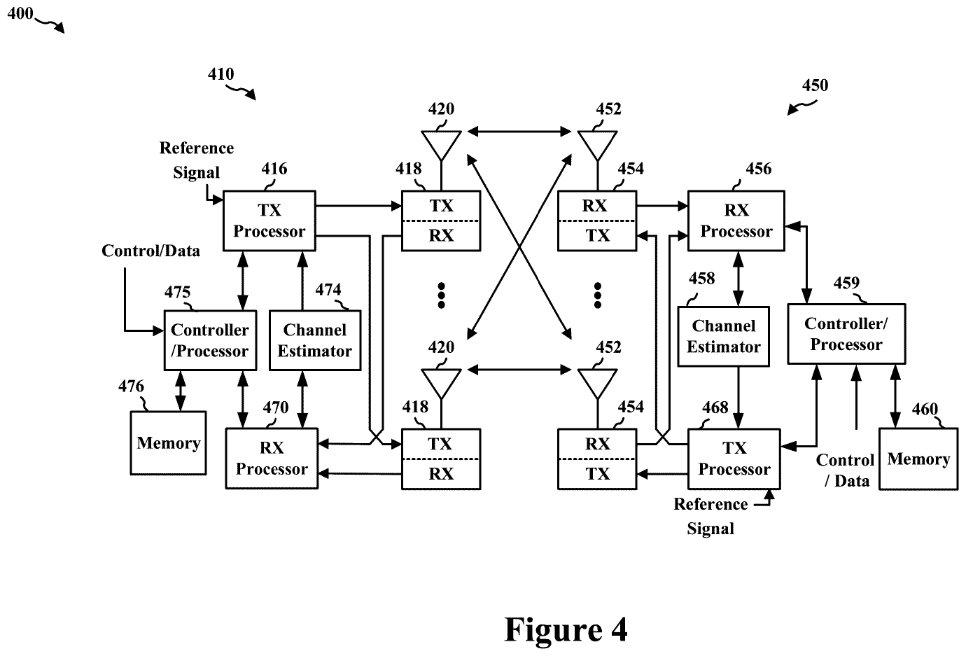

FIG. 4 is a block diagram of a base station 410 in communication with a UE 450 in an access network 400. In the downlink, IP packets from the EPC 160 may be provided to a controller/processor 475. The controller/processor 475 implements Layer 2 (L2) and Layer 3 (L3) functionality. L3 includes an RRC layer, and L2 includes a SDAP layer, a PDCP layer, an RLC layer, and a MAC layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 416 and the receive (RX) processor 470 implement Layer 1 (L1) functionality associated with various signal processing functions. L1, which includes a PHY layer, may include error detection on the transport channels, FEC coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna 420 via a separate transmitter 418TX. Each transmitter 418TX may modulate an RF carrier with a respective spatial stream for transmission.

At the UE 450, each receiver 454RX receives a signal through at least one respective antenna 452. Each receiver 454RX recovers information modulated onto an RF carrier and provides the information to the receive (RX) processor 456. The TX processor 468 and the RX processor 456 implement L1 functionality associated with various signal processing functions. The RX processor 456 may perform spatial processing on the information to recover any spatial streams destined for the UE 450. If multiple spatial streams are destined for the UE 450, they may be combined by the RX processor 456 into a single OFDM symbol stream. The RX processor 456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements L3 and L2 functionality.

The controller/processor 459 can be associated with a memory 460 that stores program codes and data. The memory 460 may be referred to as a computer-readable medium. In the uplink, the controller/processor 459 provides demultiplexing between transport and logical channels, packet reassembly, deciphering, header decompression, and control signal processing to recover IP packets from the EPC 160. The controller/processor 459 is also responsible for error detection using an ACK and/or NACK protocol to support HARQ operations.

Similar to the functionality described in connection with the downlink transmission by the base station 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna 452 via separate transmitters 454TX. Each transmitter 454TX may modulate an RF carrier with a respective spatial stream for transmission.

The uplink transmission is processed at the base station 410 in a manner similar to that described in connection with the receiver function at the UE 450. Each receiver 418RX receives a signal through at least one respective antenna 420. Each receiver 418RX recovers information modulated onto an RF carrier and provides the information to a RX processor 470.

The controller/processor 475 can be associated with a memory 476 that stores program codes and data. The memory 476 may be referred to as a computer-readable medium. In the uplink, the controller/processor 475 provides demultiplexing between transport and logical channels, packet reassembly, deciphering, header decompression, control signal processing to recover IP packets from the UE 450. IP packets from the controller/processor 475 may be provided to the EPC 160. The controller/processor 475 is also responsible for error detection using an ACK and/or NACK protocol to support HARQ operations.

In some aspects, at least one of the TX processor 468, the RX processor 456, and the controller/processor 459 may be configured to perform aspects in connection with the command 198 of FIG. 1.

In some other aspects, at least one of the TX processor 416, the RX processor 470, and the controller/processor 475 may be configured to perform aspects in connection with the command 198 of FIG. 1.

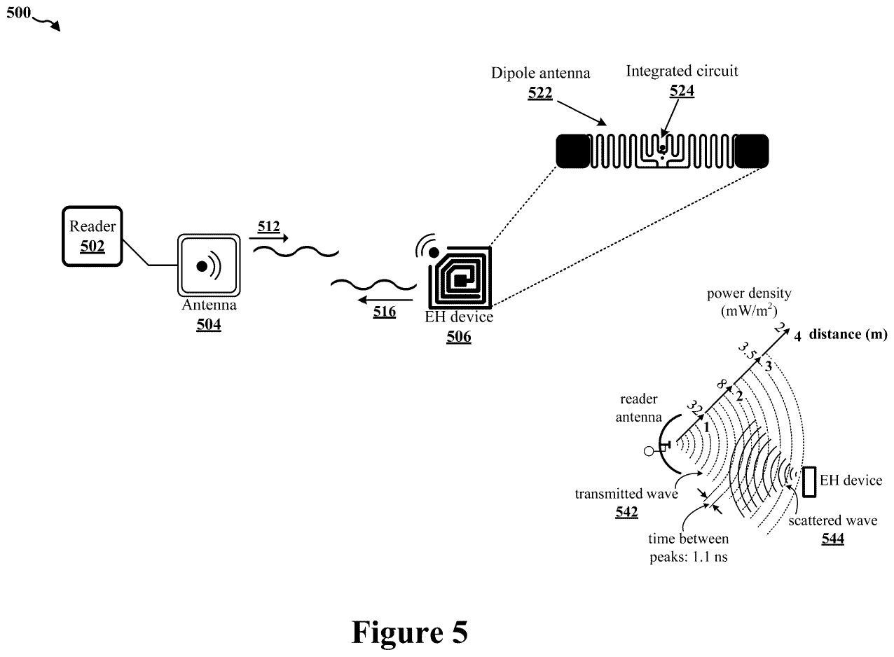

FIG. 5 is a block diagram illustrating an example of backscatter communication between an EH device 506 and an RFID reader 502 in an RFID system 500. As illustrated, when the RFID reader 502 is brought within range of the EH device 506 such that an interrogatory pulse 512 transmitted from the RFID reader antenna 504 sufficiently illuminates the dipole antenna 522 of the EH device 506, an integrated circuit (IC) 524 may modulate the load according to the data 516 that is to be transmitted back to the reader 502.

Effectively, the RF system 500 uses the transmitted wave 542 from the antenna 504 to convey some encoded data from the EH device 506 to the reader 502. The EH device 506 converts the transmitted wave 542 into μWs of electricity. Even at distances of several meters (m), the power density (expressed as milliwatts (mW) per m²) includes a number of mW that exceeds the amount consumed by the EH device 506. Thus, the transmitted wave 542 provides sufficient power for the EH device to modify and reflect a scattered wave 544 onto which the digital data stored at the EH device 506 is encoded.

Such an RFID system may be used as an alternative or supplement to some other technologies, such as narrowband IoT (NB-IoT). For example, passive EH devices may consume less power and may be less expensive than NB-IoT devices, while also featuring a higher data rate. Table 1 illustrates backscatter (RFID) technology in relation to NB-IoT technology.

TABLE 1

| | Battery | | Power | | Price | |
|---|---|---|---|---|---|---|
| Technology | (tag) | Range | (tag) | | (tag) | Date rate |
| Backscatter | No | <10 m | 10-30 | μW | ≤$0.30 | <640 |
| (RFID) | | | | | | kilobits per |
| | | | | | | second |
| | | | | | | (kbps) |
| NB-IoT | Yes | <10 | ≈200 | mW | >$1 | <159 kbps |
| | | kilometers | | | | |
| | | (km) | | | | |

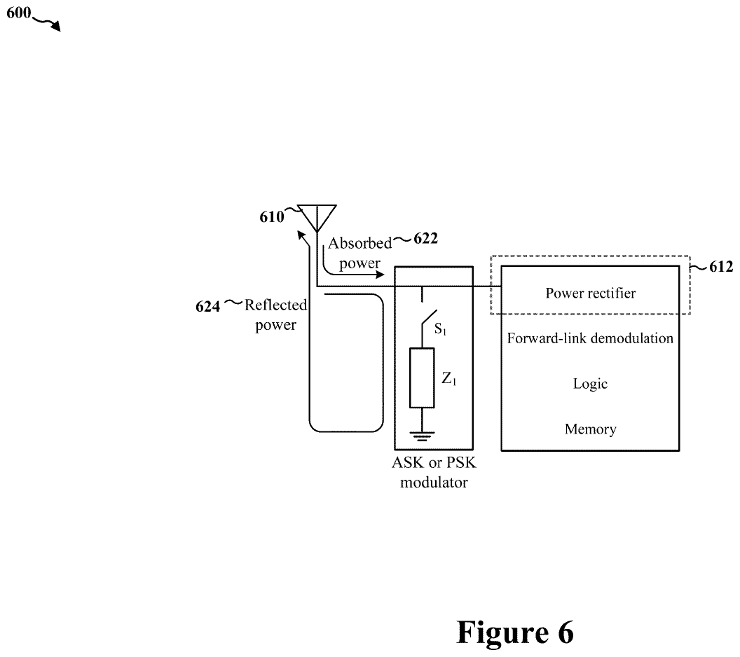

FIG. 6 is a block diagram illustrating another example of an EH device 600. The EH device 600 may be a passive EH device that features, inter alia, a power rectifier 612, logic, memory, forward-link demodulator, and/or amplitude-shift keying (ASK) or phase-key shifting (PSK) modulator.

An interrogatory pulse or other signal may be received at the antenna 610 of the EH device 600. In some aspects, the antenna 610 may be a patch antenna. The pulse may be captured at the antenna 610 as absorbed power 622, which may be supplied to the power rectifier 612.

The power rectifier 612 may be configured to convert the alternating current (AC) of the absorbed power to a direct current (DC). According to various aspects, approximately thirty (30) percent (%) of the pulse may be converted to energy usable by the EH device 600. The power rectifier 612 may supply the converted power to the components of the EH device 600, such as the logic, memory, forward-link demodulator, etc. Data stored in memory of the EH device 600 may be modulated onto the pulse, which may be transmitted as reflected power 624.

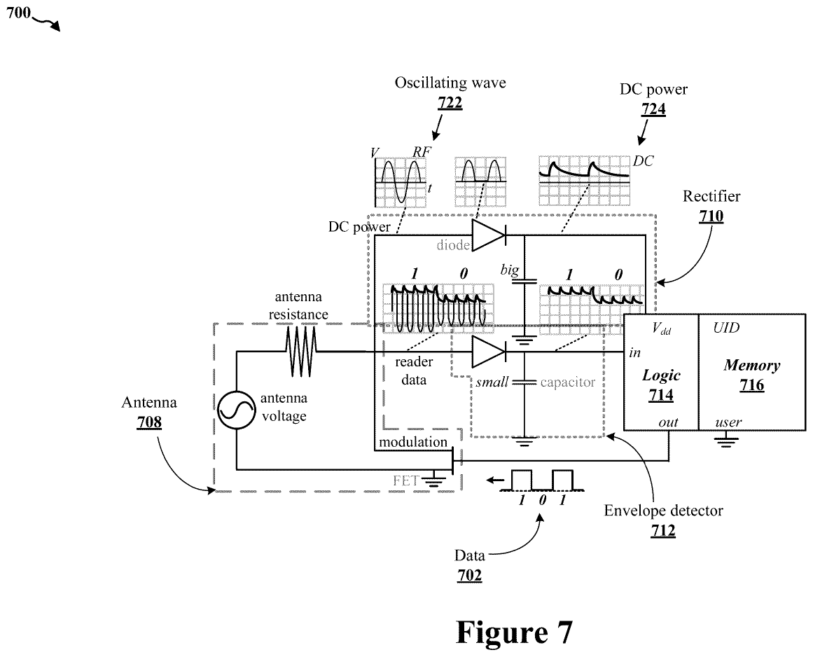

FIG. 7 is a block diagram illustrating an example of a power rectifier 710 of an EH device 700. As described with respect to FIG. 6, an interrogatory pulse may be received at the antenna 708. The interrogatory pulse may be an RF wave, and therefore, may be an oscillating wave 722. The antenna 708 may provide the oscillating wave 722 to the rectifier 710, such that the rectifier 710 is provided AC power.

The rectifier 710 may include, among other various components, an envelope detector 712, which itself may include at least one diode and at least one capacitor. The envelope detector 712 may obtain the oscillating wave 722, which may have a signal modulated thereon. The capacitor may store the charge from the oscillating wave 722, for example, on the rising edge of the signal. The capacitor releases the charge as the amplitude of the oscillating wave 722 falls, at which point the diode may rectify the oscillating wave 722, e.g., such that current flows from the diode when input to a positive terminal is at a higher potential than input to a negative terminal.

The output of the envelope detector 712 may be a pulsed DC signal, which may flow from the rectifier 710 as DC power 724. Accordingly, the logic 714 and memory 716 may be supplied a drain voltage. The logic 714 may modulate data 702, such as a unique identifier (UID) stored in memory 716, onto the reflected oscillating wave so that the data 702 is transmitted from the EH device 700 when illuminated by an RFID reader.

In some aspects, at least one of the antenna 708, the rectifier 710, the envelope detector 712, the logic 714, and/or the memory 716 may be configured to perform aspects in connection with the command 198 of FIG. 1.

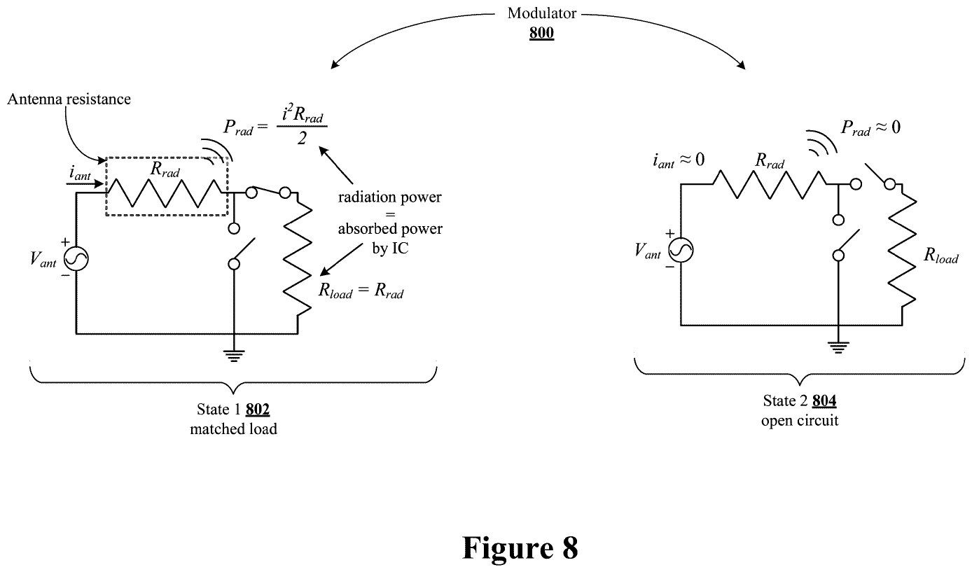

FIG. 8 is a block diagram illustrating examples states 802, 804 of a modulator 800 configured in an EH device. The modulator 800 may be an ASK modulator.

Illustratively, the modulation efficiency of the modulator 800, which may be the ratio of the practical or observed radiation power to the ideal radiation power, may be one-third (e.g., approximately five (5) decibels (dB) loss).

In state 1 802, in which the load is matched, the radiation resistance R_{RAD} may be equal to the load resistance R_{LOAD} in the modulator 800. Thus, the modulator 800 may be in a state 802 in which the load is matched, for example, between an IC and antenna resistance. Radiation power PRAD in this load matched state 802 may be equal to the quotient of the product of the antenna current squared multiplied with the radiation resistance R_{RAD} divided by two (2).

Also in the matched load state 802, the radiation power PRAD may be equal to the absorbed power at the IC R_{LOAD}. When the IC and the antenna resistance result are (approximately) load matched, the absorbed power at the IC R_{LOAD} may be sufficient for backscatter power. The current going into the antenna lant may encounter antenna resistance, or radiation resistance R_{RAD}, but the absorbed power at the IC R_{LOAD} may be sufficient to overcome such resistance.

In contrast to state 1 802, state 2 804 illustrates an open circuit in which the load resistance R_{LOAD} in the modulator 800 is mismatched with the antenna resistance, or radiation resistance R_{RAD}. The current going into the antenna lant may encounter antenna resistance, or radiation resistance R_{RAD}. The radiation resistance R_{RAD} may be equal to the load resistance R_{LOAD} in the modulator 800.

Radiation power PRAD in this load mismatched state 804 may be approximately equal zero (0). Consequently, the radiation power PRAD may be approximately equal to zero. Where the radiation power PRAD is approximately equal to zero, then the current going into the antenna lant may also be zero (0). Where the current going into the antenna is approximately zero, an insufficient amount of power has been collected from the interrogatory signal.

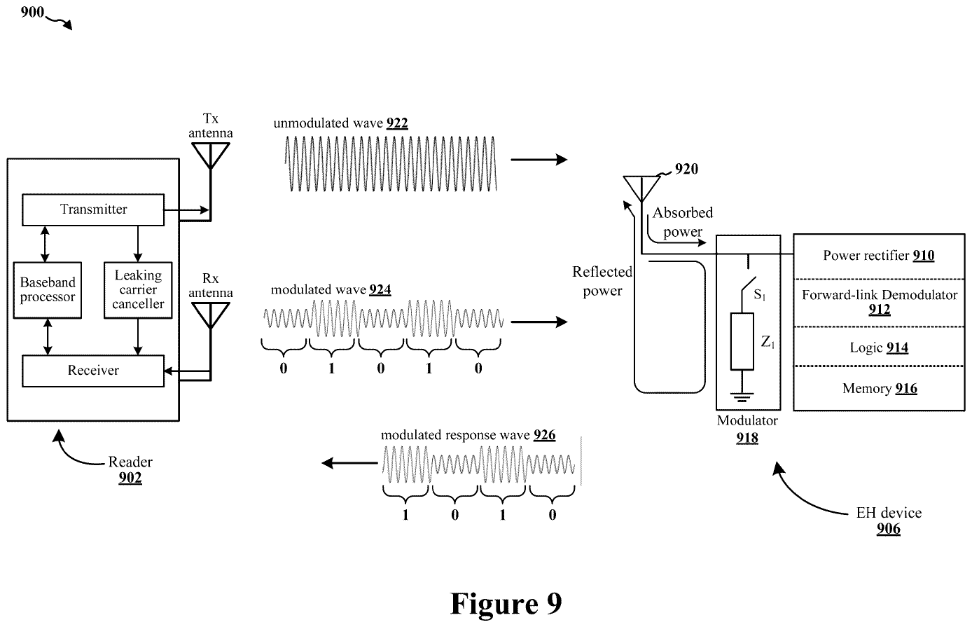

FIG. 9 is a block diagram illustrating example signalling 900 communicated between an RFID reader 902 and an EH device 906. When the reader 902 is within range of the EH device 906, the reader may transmit an unmodulated wave 922, which may be an unmodulated continuous wave having a constant amplitude and frequency.

The EH device 906 may receive the unmodulated wave 922, which may supply power to the EH device 906, e.g., via the power rectifier 910, and in particular, the forward-link demodulator 912, logic 914, and memory 916.

The reader 902 may further transmit a modulated wave 924. Data and/or control information from the reader 902 intended for the EH device 906 may be modulated onto a continuous wave, such that a set of bits of data and/or control information is carried on the wave 924. The modulated wave 924 may be a continuous wave, e.g., having a (approximately) constant frequency, and each set of wavelengths onto which a “0” is modulated may have one amplitude whereas each other set of wavelengths onto which a “1” is modulated may have another amplitude (e.g., an amplitude greater than that of the sets of wavelengths onto which a “0” is modulated).

The EH device 906 may receive the modulated wave 924, which may be obtained by the forward-link demodulator 912 via the antenna. The forward-link demodulator 912 may demodulate the modulated wave 924 in order to obtain the sequence of bits modulated thereon. The sequence of bits may be supplied to the logic 914, which may be configured to read and/or process the sequence of bits according to the data and/or control information conveyed thereby.

For example, the sequence of bits may include a request for data (e.g., a UID) from the EH device 906. The data of the EH device 906 may be stored in the memory 916. In response to the request conveyed by the sequence of bits, the logic 914 may obtain the data from the memory 916 and may configure the data to be received and read by the reader 902. The modulator 918 may modulate the data, e.g., via PSK and ASK, onto a modulated backscatter wave 926, which may include the reflection of at least a portion of the absorbed unmodulated wave 922 and/or modulated wave 924. The antenna 920 may transmit the modulated backscatter wave 926 having the data of the EH device 906 modulated thereon.

The reader 902 may receive the modulated backscatter wave 926, e.g., at the Rx antenna and to the receiver. The receiver of the reader 902 may provide the modulated backscatter wave 926 to the baseband processor.

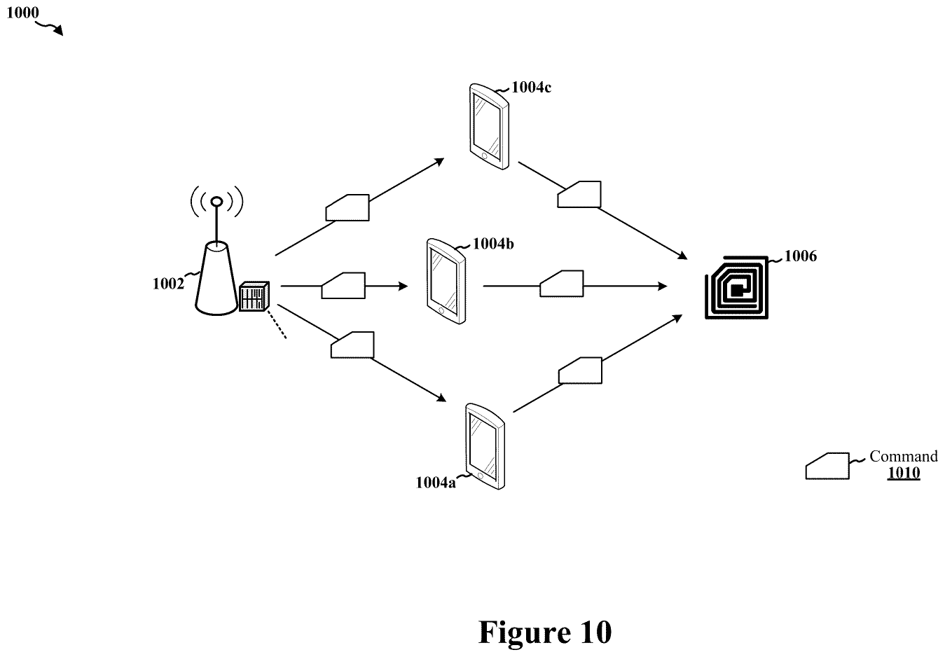

FIG. 10 is a block diagram illustrating an example wireless communications system 1000 in which a set of UEs 1004a-1004c is configured to relay a command 1010 to an EH device from a network node 1002. While the wireless communications system 1000 is illustrated and described with UEs 1004a-1004c, the various concepts and aspects described herein may be implemented in one or more other devices or types of devices without departing from the scope of the present disclosure. For example, the various concepts and aspects described with respect to each of the UEs 1004a-1004c may be implemented in a base station, relay node, RAN node, IAB device, or other network entity or network node. Further to this point, communication between the UEs 1004a-1004c (or other node(s) or device(s) and the EH device 1006 may occur on various different interfaces, depending upon the implementation of the device(s) relaying commands to the EH device 1006. For example, a UE, network node, or other network entity may communicate with the EH device 1006 on at least one of a sidelink interface, a Uu interface, PC5 interface, and/or another interface or link. In some aspects, the level of signalling (e.g., L1, L2, and/or L3 signalling) and/or type of signalling (e.g., unicast, groupcast, and/or broadcast) may be based on the interface used between the network node 1002 and the UEs 1004a-1004c (or other node(s) or device(s)), which may be different from the interface between the UEs 1004a-1004c (or other nodes(s) or device(s)) and the EH device 1006. In some other aspects, the network node 1002 may transmit the command on the Uu interface through unicast (e.g., per UE), groupcast MAC control element (CE), groupcast RRC signalling, and/or broadcast RRC signalling (while both MAC-CE and RRC signalling may be carried on a PDSCH, both MAC-CE and RRC signalling may be considered higher layer signals).

With the adoption of RFID technology into the 3GPP standards (e.g., 5G and/or 6G), the contexts and applications for EH devices may be expected to appreciably increase. However, EH devices with only static values (e.g., UIDs) may limit the usefulness and practicality of EH device implementation. Often those static values are hardcoded into the EH device, and so may be unchangeable. Moreover, even if such values were changeable, the potential exists for at least the first read operation to return some stale or erroneous data, since no power will have been supplied to the EH device for a duration sufficient to power the EH device.

Thus, there exists a need for solutions to dynamically add, delete, update, or otherwise perform an operation(s) data on a EH device in advance of the EH device being read. The present disclosure describes various mechanisms and techniques, whereby commands (e.g., instructions, requests, etc.) for EH devices are generated at the network (e.g., at a network node, base station, etc.).

As UEs are now or soon will be ubiquitous across nearly every location and context, EH devices may be assumed to be within range of multiple RF sources (e.g., two or more UEs). UEs 1004a-1004c may supply illuminating pulses that provide power to EH devices. Further, UEs 1004a-1004c may relay a command 1010 to an EH device 1006 via modulated waves.

According to various examples, a command 1010 may be categorized as at least one of a positioning command (e.g., a command querying spatial and/or geographic information, orientation information, direction and/or rate of travel information, acceleration information, etc. from the EH device 1006), a medical command (e.g., a command to change, adjust, inquire, and/or acquire medical information from a sensor associated with the EH device 1006), a lost-item command (e.g., a command intended for EH devices that are remotely located relative to an owner or user of the EH devices; potentially, any lost or misplaced EH device may respond to such lost-item commands). In some aspects, such commands 1010 may instruct the EH device 1006 to set at least one parameter of the EH device 1006, such as a UID or other parameters stored at the EH device 1006.

Such enhancements related to EH devices may be implemented on top of the existing air interface because the data rate of EH device data is relatively low (e.g., on the scale of kilobytes). Therefore, a network node 1002 may send the command 1010 to the EH device 1006 via a group of UEs 1004a-1004c in a relatively small number (e.g., less than 10) of sub-slots, symbols, and/or RBs.

In still further aspects of the present disclosure, the reliability of issuing commands to EH devices is addressed. In particular, the group of UEs 1004a-1004c may be sufficient to provide power to the EH device 1006 that is sufficient for some ACK/NACK feedback to be transmitted by the EH device 1006 in connection with receiving the EH device 1006.

In some further aspects, more than one hop may exist from the network node 1002 to the EH device 1006. For example, some paths between the network node 1002 and the EH device 1006 may include multiple hops—e.g., a path from the network node 1002 to the EH device 1006 may include a first hop from the network node 1002 to a first UE and a second hop from the first UE to the second UE(s), and the second UE(s) may communicate with the EH device 1006 without any intervening relay devices. In some such examples, the hop between the first UE and the second UE(s) may use sidelink control information (SCI), such as SCI-1 or SCI-2 (e.g., unicast or groupcast SCI-2) or may use PSSCH (e.g., groupcast as sidelink may support groupcast PSSCH or unicast to each UE) or may use a new unicast, groupcast, or broadcast PHY signalling or channel or unicast/groupcast/broadcast PC5-MAC-CE, or unicast, groupcast, or broadcast PC5-RRC signalling (each of the foregoing may carry the information described herein via DCI and/or short PDSCH).

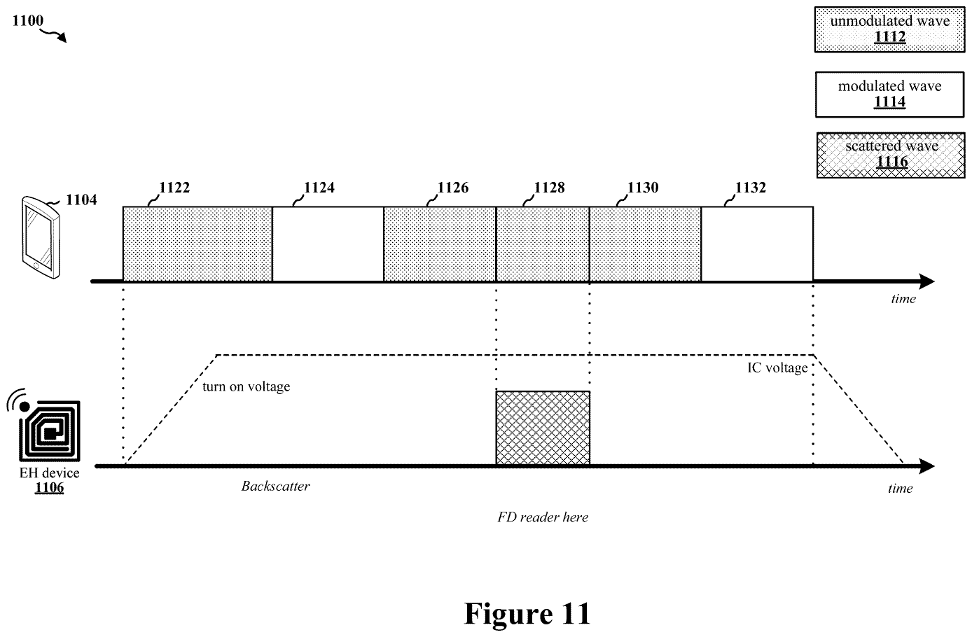

FIG. 11 is a timing diagram illustrating an example of wireless communications 1100 between an RFID reader 1104 and an EH device 1106. At a first time period 1122, the RFID reader 1104 may transmit an unmodulated wave 1112 to the EH device 1106. The unmodulated wave 1112 may be a continuous wave. The EH device 1106 may receive the unmodulated wave 1112, which may “turn on” the EH device 1106 by supplying a voltage to the EH device 1106. In some aspects, the first time period 1122 may be approximately equal to or greater than 400 μs.

At a second time period 1124, the reader 1104 may transmit a modulated wave 1114 to the EH device 1106. The modulated wave 1114 may be a continuous wave onto which a command is modulated. The EH device 1106 may receive the modulated wave 1114 and may demodulate the command carried thereon. The modulated wave 1114 may further continue to supply power to the EH device 1106. In some aspects, the power level of the modulated wave 1114 may be at least −20 decibel-milliwatts (dBm).

At a third time period 1126, the reader 1104 may resume transmission of an unmodulated wave 1112. The EH device 1106 may receive the unmodulated wave 1112 at the third time period 1126, and the EH device 1106 may draw power therefrom in order to maintain the “turned on” state of the EH device 1106. In some aspects, the power level of the unmodulated wave 1112 may be at least −20 decibel-milliwatts (dBm).

At a fourth time period 1128, the reader 1104 may continue with transmission of an unmodulated wave 1112. In some aspects, the power level of the unmodulated wave 1112 may be at least −20 dBm. The EH device 1106 may receive the unmodulated wave 1112 at the fourth time period 1128. The EH device 1106 may use the unmodulated wave 1112 as a carrier wave onto which to modulate data of the EH device 1106 and/or the EH device 1106 may draw power from the unmodulated carrier wave in order to modulate data onto a wave. For example, the EH device 1106 may modulate data onto a scattered wave 1116 that is reflected to the reader 1104. The reader 1104 may receive the scattered wave 1116, and the reader 1104 may demodulate the scattered wave 1116 in order to obtain the data of the EH device 1106.

At a fifth time period 1130, the RFID reader 1104 may transmit an unmodulated wave 1112 to the EH device 1106. The unmodulated wave 1112 may be a continuous wave. The EH device 1106 may receive the unmodulated wave 1112, which may maintain the “turned on” state of the EH device 1106 by supplying a voltage to the EH device 1106. In some aspects, the power level of the unmodulated wave 1112 may be at least −20 dBm.

At a sixth time period 1132, the reader 1104 may transmit a modulated wave 1114 to the EH device 1106. The modulated wave 1114 may be a continuous wave onto which a command is modulated. The EH device 1106 may receive the modulated wave 1114 and may demodulate the command carried thereon. The modulated wave 1114 may further continue to supply power to the EH device 1106, for example, the modulated wave 1114 may provide an IC voltage. In some aspects, the power level of the modulated wave 1114 may be at least −20 dBm.

Once the reader 1104 ceases to transmit waves 1112, 1114 to the EH device 1106, the EH device 1106 may lack a power source from which to draw power and so may “turn off.”

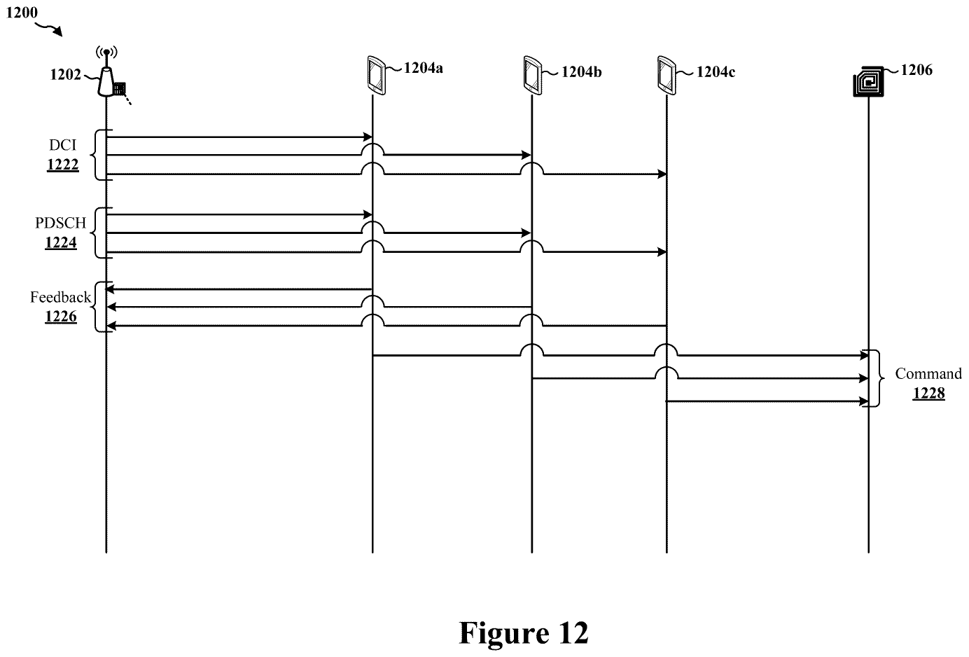

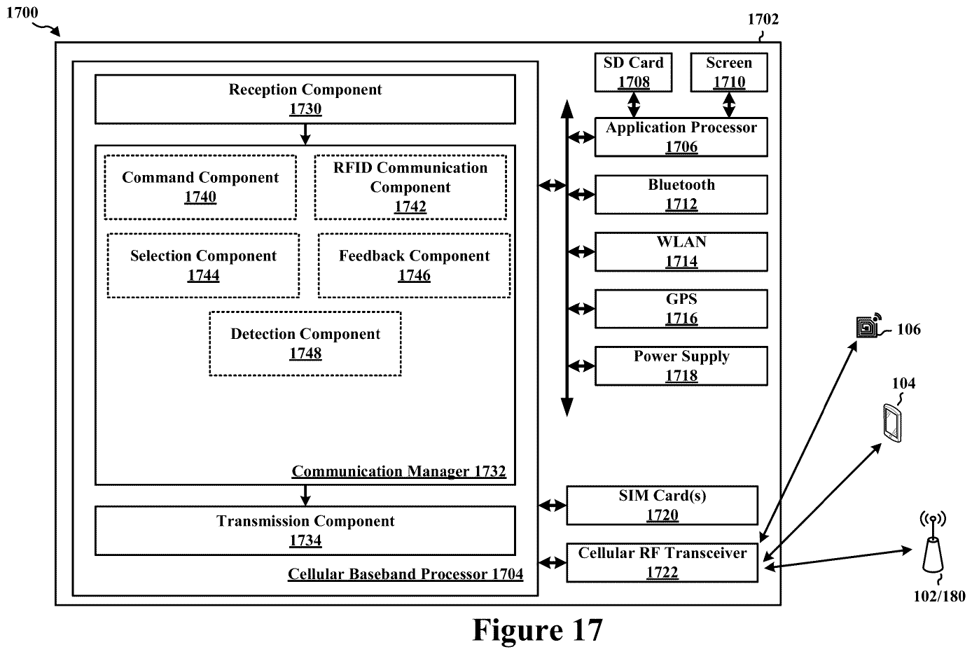

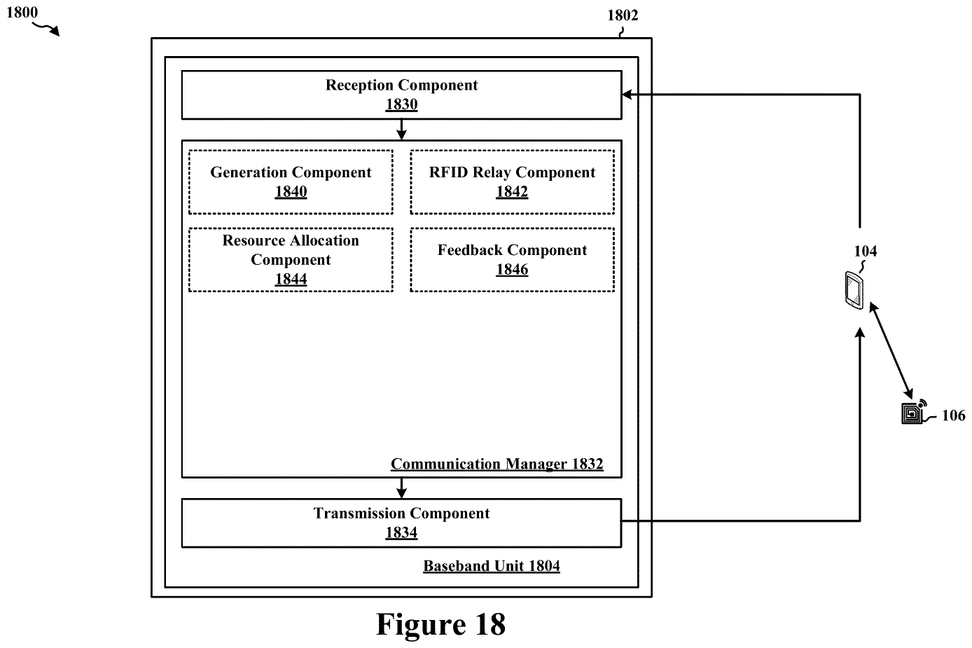

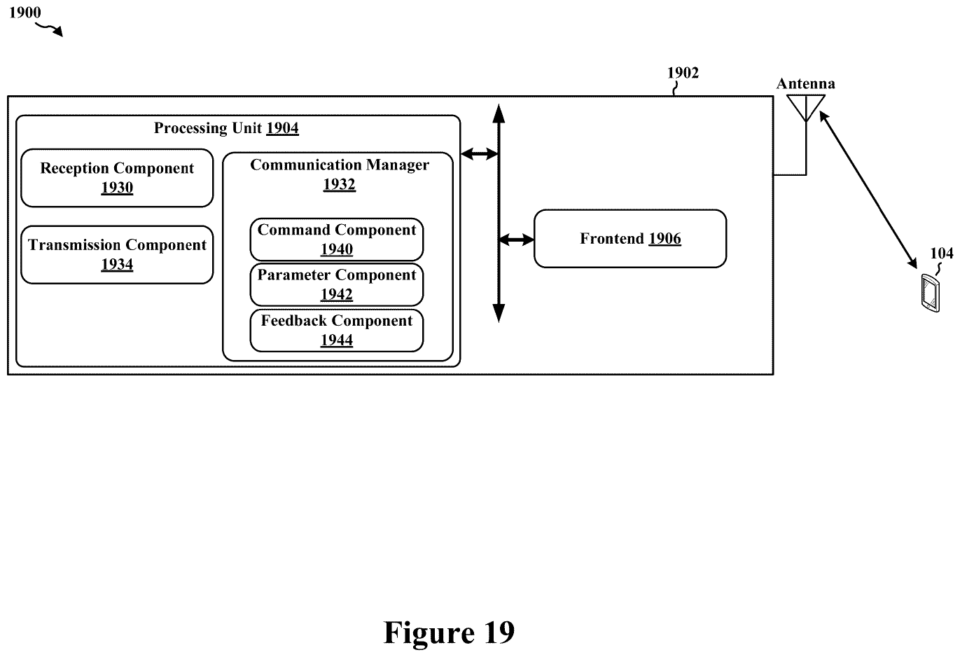

FIG. 12 is a call flow diagram illustrating example operations 1200 for communication of a command 1228 generated by a network node 1202 to an EH device 1206 via a set of UEs 1204a-1204c. Each of the UEs 1204a-1204c may be implemented as one of the UE 104 of FIG. 1, the UE 450 of FIG. 4, one of the UEs 1004a-1004c of FIG. 10, the reader 1104 of FIG. 11, and/or the apparatus 1702 of FIG. 17. The network node 1202 may be implemented as one of the base station 102/180 of FIG. 1, the base station 410 of FIG. 4, the network node 1002 of FIG. 10, and/or the apparatus 1802 of FIG. 18. The EH device 1206 may be implemented as one of the EH device 106 of FIG. 1, the EH device 506 of FIG. 5, the EH device 600 of FIG. 6, the EH device 700 of FIG. 7, the EH device 906 of FIG. 9, the EH device 1006 of FIG. 10, the EH device 1106 of FIG. 11, and/or the apparatus 1902 of FIG. 19.

The EH device 1206 may be separately housed from each of the first UE 1204a, second UE 1204b, and third UE 1204c. That is, the EH device 1206 may not be collocated with any of the UEs from which a command is received, as described in the present disclosure.

The network node 1202 may determine a set of UEs 1204a-1204c that are proximate to an EH device 1206 to which the network node 1202 intends to transmit a command 1228. For example, the network node 1202 may determine the set of UEs based on respective proximities of each of the UEs to the EH device 1206 (e.g., via UE positioning) and/or based on which UEs have most recently served the EH device 1206.

The network node 1202 may generate a command for the EH device 1206, which may be conveyed via some data and/or control information. For example, the network node 1202 may generate a command that instructs the EH device 1206 to set a value of a parameter. In some aspects, the command may instruct the EH device 1206 to change an existing value of a parameter. In some other aspects, the command may instruct the EH device 1206 to add or remove a value of a parameter and/or to add or remove a parameter itself.

The network node 1202 may transmit DCI 1222 to the determined set of UEs 1204a-1204c. In some aspects, the DCI 1222 may be a group common (GC) DCI that is transmitted to a group of UEs 1204a-1204c. In some aspects, the DCI 1222 may identify the group of UEs 1204a-1204c, which may be a subgroup of another group of UEs. In some aspects, the network node 1202 may configure the DCI 1222 to be dedicated to the group of UEs 1204a-1204c that is configured to relay commands to the EH device 1206. The network node 1202 may configure the DCI 1222 on a set of resources commonly allocated to, and/or with a set of parameters commonly assigned for, the UEs 1204a-1204c configured to serve the EH device 1206. For example, the network node 1202 may configure one or more of a CORESET, a search space, a search space set group (SSSG), a radio network temporary identifier (RNTI), and/or another set of resources or parameters to commonly used by the UEs 1204a-1204c included in a group configured to communicate with the EH device 1206.

In some aspects, the network node 1202 may include, in the DCI 1222, the data and/or control information that is intended to be relayed to the EH device 1206 by the UEs 1204a-1204c. Further, the network node 1202 may include, in the DCI 1222, a common HARQ 1D for packets communicated with the EH device 1206, an ID of the EH device 1206 (or EH devices), a class of the EH device 1206 (e.g., passive, semi-passive, or active), a class of the item with which the EH device 1206 is associated (e.g., the EH device 1206 may be attached to clothing, the EH device 1206 may be used to track perishable comestibles, etc.), a resource configuration associated with a link that is configured to carry the command to the EH device 1206, and/or other information that may be used alone or in the aggregate to identify and/or communicate with the EH device 1206.

In some other aspects, the network node 1202 may include, in the DCI 1222, information indicating an allocation of resources on which a PDSCH is scheduled. In such other aspects, the network node 1202 may transmit the data and/or control information intended for the EH device 1206, as well as other information identifying the EH device 1206, on the PDSCH 1224.

In one example of such other aspects, the PDSCH 1224 may be a groupcast short PDSCH or a GC PDSCH. In another example of such other aspects, the network node 1202 may unicast the DCI 1222 and/or the PDSCH 1224. In some such other examples, the network node 1202 may provide the time from the CG or unicast DCI to the CG or unicast PDSCH in the DCI (e.g., for each UE or group of UEs, when the PDSCH is unicast).

In some aspects, the network node 1202 may transmit the DCI 1222 and/or the PDSCH 1224 (e.g., DCI and groupcast PDSCH scheduled thereby) on at least one configured common frequency resource (CFR). For example, the network node 1202 may schedule a groupcast signal (e.g., on the PDSCH 1224) by transmitting a grant (e.g., configured grant or dynamic grant) on a CFR, or in multiple CFRs, dedicated to the group of UEs 1204a-1204c configured to relay the command 1228 to the EH device 1206.

A CFR may be at least one resource that is configured to carry groupcast signalling to a group of UEs and/or configured to carry information indicating a schedule or resource allocation for the groupcast signalling. For UEs capable of receiving multicast transmissions in an RRC_Connected state, a CFR may be configured for groupcast (or multicast) in a downlink dedicated BWP via unicast RRC signalling, with the CFR having a bandwidth less than or equal to, and a numerology equal to, the downlink dedicated BWP in which the CFR is included. HARQ ACK feedback and/or slot-level repetition for such CFR may be supported for reliability. For UEs capable of receiving broadcast transmissions in RRC_Connected, RRC_Inactive, or RRC_Idle states, a CFR for broadcast a multicast control channel (MCCH) and/or multicast traffic channel (MTCH) may be configured via a SIB (e.g., SIB20), with the CFR having a bandwidth greater than or equal to, and a numerology equal to, CORESET0. Slot-level repetition for such CFR may be supported for reliability.

In one implementation, the network node 1202 may allocate a respective time and frequency resource for each CFR that is dedicated to the group of UEs 1204a-1204c configured to relay commands to the EH device 1206. In some aspects, the network node 1202 may transmit a configuration of a CFR in DCI. For example, the network node 1202 may configure one or more of a CORESET, a search space, an SSSG, an RNTI, and/or another set of resources or parameters for DCI carrying a configuration of a CFR to the UEs 1204a-1204c included in a group configured to communicate with the EH device 1206. The network node 1202 may transmit such DCI on a CFR or on one or more other resources separate from the CFR. To that end, the network node 1202 may indicate, via DCI, a correspondence with a CFR, e.g., by transmitting the DCI on the corresponding CFR or by indicating a CFR index in the DCI that identifies the corresponding CFR.

In one illustrative example of such other implementation, in order to transmit a command 1228 that is associated with a class X of EH devices, which may include the EH device 1206, the network node 1202 may allocate a set of resources {u, y, z} as CFRs for the class X of EH devices. The network node 1202 may transmit a grant associated with the command 1228 on the CFRs {u, y, z}, and therefore, the UEs 1204a-1204c may derive the class X of EH devices for which the command 1228 is intended by virtue of the associated grant being received on the CFRs {u, y, z}, may indicate to the UEs 1204a-1204c that the command 1228 is intended for the class X of EH devices.

In another illustrative example of such other implementation, in order to transmit a command 1228 that is associated with a type L of information to be read by EH devices, which may include the EH device 1206, the network node 1202 may allocate a set of resources {m, n, o, p, q} as CFRs for the type L of information. The network node 1202 may transmit a grant associated with the command 1228 on the CFRs {m, n, o, p, q}, and the UEs 1204a-1204c may derive the EH device(s) for which the type L of information is intended by virtue of the associated grant being received on the CFRs {m, n, o, p, q}.

In still another implementation, the network node 1202 may use the same CFRs for all types and/or classes of EH devices and/or for all types of information.

In some other aspects, the network node 1202 may transmit the DCI 1222 and/or the PDSCH 1224 (e.g., DCI and groupcast PDSCH scheduled thereby) on a set of configured resources that is separate from a CFR. For example, the network node 1202 may transmit the DCI 1222 and/or the PDSCH 1224 on resources separate from a CFR when the network node 1202 does not configure a CFR or the network node 1202 may transmit a dedicated resource allocation to each of the UEs 1202a-1204c via a grant (e.g., configured grant or dynamic grant).

Correspondingly, each of the UEs 1204a-1204c may be configured to receive, from the network node 1202, information indicating the command intended for the EH device 1206. As described above, the information indicating the command may be included in the DCI 1222, or the DCI 1222 may schedule resources for a PDSCH and the information indicating the command may be carried on the PDSCH.

In order to improve reliability, the UEs 1204a-1204c may be configured to provide feedback 1226 (e.g., ACK/NACK feedback) to the network node 1202 based on the information indicating the command, whether the information indicating the command is carried in the DCI 1222 or the PDSCH 1224 (or a combination thereof). For example, the network node 1202 may assign a set of resources to the UEs 1204a-1204c or may assign a respective set of resources to each of the UEs 1204a-1204c on which to report feedback 1226 for the DCI 1222 and/or the PDSCH 1224 (e.g., depending upon which of the DCI or PDSCH carries the information indicating the command).

According to various different aspects, each of the UEs 1204a-1204c may include some identifying information in the feedback 1226. For example, the feedback 1226 may include information identifying a HARQ process (e.g., a HARQ ID), which may itself correspond to an ID of the EH device 1206. In another example, the feedback 1226 may include an ID of a source or destination (e.g., the network node 1202 or the transmitting UE) and/or the feedback 1226 may include an ID of the EH device 1206.

In some aspects, when one of the UEs 1204a-1204c successfully receives and decodes the information indicating the command, the UE may report feedback 1226 indicating an ACK. However, when one of the UEs 1204a-1204c fails to successfully receive or otherwise fails to successfully decode the information indicating the command, the UE may report feedback 1226 indicating a NACK.

In some aspects, NACK-only feedback may be used. That is, when one of the UEs 1204a-1204c successfully receives and decodes the information indicating the command, the UE may refrain from reporting feedback. In the absence of any feedback from one of the UEs 1204a-1204c, the network node 1202 may assume that the UE successfully received and decoded the information indicating the command.

However, a UE may report feedback 1226 indicating a NACK if the UE fails to successfully receive or otherwise fails to successfully decode the information indicating the command. In response, to the NACK feedback, the network node 1202 may retransmit the information indicating the command (e.g., via unicast or groupcast).

Each of the UEs 1204a-c may be configured to wirelessly transmit the command to the EH device 1206 in association with configuring data on the EH device 1206. In some aspects, the command may be carried on uplink resources, downlink resources, or sidelink resources. In some other aspects, the command may be carried on resources of a link type that is differently defined than uplink, downlink, and sidelink—e.g., the command may be carried on “tag link” (e.g., “taglink”) resources or “IoT link” (e.g., “IoTlink”) resources. The network node 1202 may indicate a resources allocation on a link in the information indicating the command carried on the DCI 1222 and/or PDSCH 1224.

In some aspects, the network node 1202 may configure multiple sets of resources on which the UEs 1204a-1204c are scheduled to transmit the command to the EH device 1206. The network node 1202 may indicate the allocated sets of resources to the UEs 1204a-1204c via dynamic grants or configured grants. According to some examples of such aspects, dynamic grant and/or configured grant allocations may be configured per EH device (e.g., per EH device ID), per group of EH devices, per class and/or type of EH devices, per class and/or type of command to send to an EH device, per class and/or type of command to send to a group of EH devices or class of EH devices, or type of EH devices, and so forth.

In some aspects, each of the UEs 1204a-1204c may be configured to select one of the allocated sets of resources on which to transmit the command to the EH device 1206. For example, a UE may measure the energy on resources of at least two of the allocated sets of resources. The UE may compare the measured energies, and the UE may select the set of resources that corresponds to the lowest measured energy, as interference may be less likely on such a set of resources.

In some aspects, some or all of the UEs 1204a-1204c may implement energy- or power-based timers to select one set of resources from the multiple sets of resources. For example, such a timer may be based on the energy measured on a set of resources, such that the UE backs off for the duration of the timer based on the energy level measured on the set of resources.

In some other aspects, each of the UEs 1204a-1204c may select a respective set of resources on which to transmit the command 1228 based on the power with which the DCI 1222 and/or PDSCH 1224 is received from the network node 1202. For example, each of the UEs 1204a-1204c may select a respective set of resources on which to transmit the command 1228 as a function of received power and transmission power (e.g., the power calculated by a UE to transmit the command 1228 to the EH device 1206).

In still other aspects, each of the UEs 1204a-1204c may be assigned a respective set of resources on which to transmit the command 1228 by the network node 1202. For example, the network node 1202 may configure the sets of resources to be non-overlapping in time, such that each of the UEs 1204a-1204c transmits the command 1228 at a respective different time.

In still further aspects, the network node 1202 may assign the same set of resources to all of the group of UEs 1204a-1204c. In so doing, coherent construction may be exploited in order to improve reception by the EH device 1206. The receiver EH device 1206 may be configured to perform energy (or envelop) detection, which may involve one layer (e.g., due to the power and formfactor constraints imposed upon the EH device 1206). Therefore, coherent signals may serve to improve the strength thereof as received at the antenna of the EH device 1206.

Each of the UEs 1204a-1204c may be configured to estimate the respective channel between the UE and the EH device, and each of the UEs 1204a-1204c. From measuring the channel, each of the UEs 1204a-1204c may be able to cause a transmission to have a phase and/or amplitude that is within an acceptable range. For example, each of the UEs 1204a-1204c may select a respective beamformer (e.g., analog and/or digital), power control information (e.g., to adjust the transmit power and/or transmit power control at each UE), type and/or class of EH device, and/or or type of signal or information (e.g., to adjust the transmit power and/or transmit power control to achieve certain a certain error rate, such as a certain block, packet, or bit error rate) that may be used for transmitting the command 1228 to the EH device 1206. Based on measuring the channel with the EH device 1206, the UEs 1204a-1204 may utilize beamformers to generate waves having coherency in phase and/or amplitude sufficient to be added together at the EH device 1206.

Additionally or alternatively, the network node 1202 may be configured to indicate, to each of the UEs 1204a-1204c, a respective beamformer (e.g., analog and/or digital), power control information (e.g., to adjust the transmit power at each of the UEs 1204a-1204c), type and/or class of EH device, type of signal or other information to be read by an EH device, and/or or priority/delay condition(s) (e.g., to adjust the transmit power and/or transmit power control) so that a specific latency/delay condition and/or error rate (e.g., bit, block, and/or packet error rate) may be achieved and/or so that an appropriate amount of power is supplied to the EH device 1206 via transmission of the command 1228 to the EH device 1206. Where a UE of the UEs 1204a-1204c is configured with a single antenna beamformer (e.g., analog and/or digital), then the network node 1202 may indicate a single phase and/or amplitude and phase that the UE should use to transmit a signal. However, where a UE of the UEs 1204a-1204c has multiple RF chains and/or multiple antennas per RF chain, the network node 1202 may indicate multiple coefficients for the UE to use for each antenna. The use of multiple coefficients at multiple UEs to send to the command 1228 may enable signalling from the multiple UEs to be coherently added together, as well. The network node 1202 may include information configuring such coherent signalling (e.g., an indication of a beamformer) in DCI, on a PDSCH, and/or a combination thereof.

In some aspects, one or more transmission parameters for each of the UEs 1204a-1204c, such as power control, modulation and coding scheme (MCS), transmitted signal waveform, and the like, may be associated with (e.g., dependent upon, based upon, etc.) a type and/or class of the EH device 1206 and/or type of information (e.g., medical, positioning, metering, sensing, or another type of signalling). In some implementations, the type and/or class of the EH device 1206 may be associated with at least one of a latency and/or delay condition and/or a reliability condition (e.g., a threshold error rate, such as a bit error rate, block error rate, or packet error rate). In some examples, signalling to the EH device 1206 may be associated with relatively higher reliability conditions and/or relatively lower latency conditions—for example, signals backscattered or transmitted by ZP IoT devices associated with medical sensors may be associated with relatively higher transmit powers to achieve relatively lower latencies. In some examples, a CFR may be associated with one or more transmission parameters, and each of the UEs 1204a-1204c may be configured to derive the one or more transmission parameters from the CFR used by the network node 1202 in association with the command 1228. For example, the transmission parameters may include one or more power control adjustment parameters indicated via at least one CFR, and a UE may adjust a transmission power based on the one or more power control adjustment parameters indicated via the at least one CFR. In some other implementations, the network node 1202 may transmit one or more transmission parameters via DCI or on a PDSCH (e.g., the one or more transmission parameters may include power adjustment information that is configured on per UE basis).

In yet further aspects, the network node 1202 may instruct each of the UEs 1204a-1204c to select a respective set of resources on which to transmit the command 1228. For example, the UEs 1204a-1204c may be configured to contend for sets of resources, similar to Mode 2 for sidelink transmission as standardized in 5G NR.

The network node 1202 may include instructions on the DCI and/or PDSCH indicating to the UEs 1204a-1204c which approach is to be implemented for finding the resources on which to transmit the command 1228. For example, on the DCI 1222 and/or PDSCH 1224, the network node 1202 may indicate whether each of the UEs 1204a-1204c is instructed to select resources itself (e.g., according to one of the foregoing approaches) or whether the network node 1202 will assign a respective set of resources to each of the UEs 1204a-1204c (e.g., on an access link, such as a Uu link, on a sidelink or direct link, such as a PC5 link, or on another link, such as a new link). For example, the UEs 1204a-1204c may be configured to transmit on sets of resources in a manner that is similar to Mode 1 for sidelink transmission as standardized in 5G NR.

Each of the UEs 1204a-1204c may transmit the command 1228 on a respective set of resources, selected or assigned as described above. Correspondingly, the EH device 1206 may receive the command 1228 (e.g., as a modulated wave, which may follow an unmodulated continuous wave). The UEs 1204a-1204c may periodically or semi-persistently transmit the command 1228, e.g., until instructed to cease transmission of the command or until a time period has elapsed. For example, each of the UEs 1204a-1204c may periodically or semi-persistently transmit the command 1228 until feedback is received from the EH device 1206 and/or until instructed to cease transmission of the command 1228 by the network node 1202.

The command 1228 may be associated with configuring data at the EH device 1206. Accordingly, the EH device 1206 may execute the command 1228, such as by setting at least one parameter of the EH device 1206 according to the data and/or control information indicated in the command 1228.

In some aspects, the EH device 1206 may set the at least one parameter by changing at least one value of the at least one parameter to at least one other value indicated by the command 1228 based on data and/or control information indicated by the command 1228. In some other aspects, the EH device 1206 may set the at least one parameter by adding or deleting at least one value of the at least one parameter based on the data and/or control information indicated by the command 1228.

In some aspects, the EH device 1206 may be activated (e.g., “turned on” or otherwise configured to receive) where a threshold amount of energy is detected. In some aspects, such as those in which the EH device 1206 is implemented as a passive EH device or ZP IoT device, the threshold amount of energy may be an amount of energy sufficient to supply power to the EH device 1206 for a duration that allows the EH device to set at least one parameter of the EH device 1206. In some other aspects, such as those in which the EH device 1206 is implemented as an active EH device or a semi-active EH device, the threshold amount of energy may be an amount of energy that indicates to the EH device that the command 1228 is intended for the EH device.

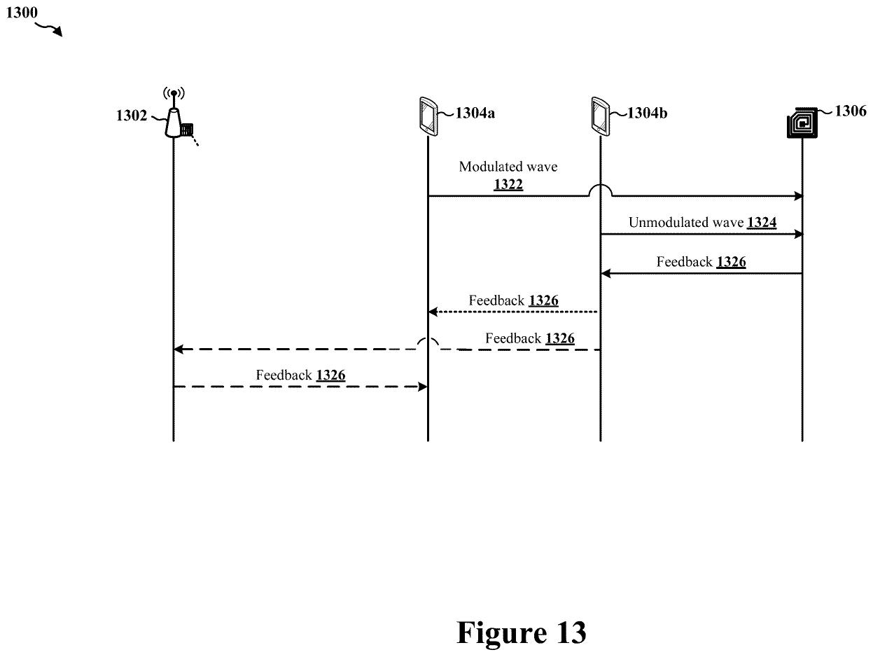

FIG. 13 is a call flow diagram of example operations 1300 for feedback provided by an EH device 1306 to a command generated by a network node 1302. Each of the UEs 1304a, 1304b may be implemented as one of the UE 104 of FIG. 1, the UE 450 of FIG. 4, one of the UEs 1004a-1004c of FIG. 10, the reader 1104 of FIG. 11, one of the UEs 1204a-1204c of FIG. 12, and/or the apparatus 1702 of FIG. 17. The network node 1302 may be implemented as one of the base station 102/180 of FIG. 1, the base station 410 of FIG. 4, the network node 1002 of FIG. 10, the network node 1202 of FIG. 12, and/or the apparatus 1802 of FIG. 18. The EH device 1306 may be implemented as one of the EH device 106 of FIG. 1, the EH device 506 of FIG. 5, the EH device 600 of FIG. 6, the EH device 700 of FIG. 7, the EH device 906 of FIG. 9, the EH device 1006 of FIG. 10, the EH device 1106 of FIG. 11, the EH device 1206 of FIG. 12, and/or the apparatus 1902 of FIG. 19.

The EH device 1306 may be separately housed from each of the first UE 1304a, second UE 1304b, and third UE 1304c. That is, the EH device 1306 may not be collocated with any of the UEs from which a command is received, as described in the present disclosure.

In some aspects, the first UE 1304a and the second UE 1304b may be implemented at the same UE. For example, some or all of the operations described with respect to the second UE 1304b may be practiced by the first UE 1304a. In some other aspects, the first UE 1304a and the second UE 1304b may be separate UEs. For example, the first UE 1304a and the second UE 1304b may include separate housings and/or separate network subscriptions and/or may not be collocated.

As shown in FIG. 13, the first UE 1304a may transmit a modulated wave 1322 to the EH device 1306. The modulated wave 1322 may have a command modulated thereon, such as the command 1228 described with respect to FIG. 12. The modulated wave 1322 may be a continuous wave.

To improve reliability of command communication, the EH device 1306 may be configured to provide feedback 1326 associated with the modulated wave 1322. For example, the EH device 1306 may be configured to provide feedback 1326 indicating an ACK when the EH device 1306 successfully receives and demodulates the command from the modulated wave 1322. However, the EH device 1306 may be configured to provide feedback 1326 indicating a NACK when the EH device 1306 does not successfully receive or does not successfully demodulate the command from the modulated wave 1322.

The EH device 1306 may be configured to transmit the feedback 1326 to one or both of the UEs 1304a, 1304b. In some aspects, such as aspects in which the EH device 1306 is an active EH device or a semi-passive EH device, the EH device 1306 may have the capability to generate waveforms, and therefore, the EH device 1306 may generate a waveform, modulate the feedback 1326 onto the generated waveform, and transmit the modulated wave indicating the feedback 1326 to one or both of the UEs 1304a, 1304b.

In some other aspects, such as aspects in which the EH device 1306 is a passive EH device, the second UE 1304b may be configured to transmit an unmodulated wave 1324 (e.g., a continuous wave) to the EH device 1306. For example, the second UE 1304b may be configured to transmit the unmodulated wave 1324 after each repeated transmission of the modulated wave 1322. The time at which the second UE 1304b is to transmit the unmodulated wave may be configured by the network node 1302, and conveyed to the second UE 1304b via DCI and/or PDSCH. Such a time may further convey the resource (in the time domain) that the second UE 1304b is to monitor in order to receive the feedback 1326.

The unmodulated wave 1324 may supply the waveform onto which the EH device 1306 may modulate the feedback 1326, which may be backscattered to the UEs 1304a, 1304b to convey the feedback 1326 thereto. In some aspects, the second UE 1304b may receive information indicating the resources on which to transmit the unmodulated wave 1324 by the network node 1302. The EH device 1306 may include some identifying information with the feedback 1326. For example, the EH device 1306 may include a HARQ ID with the feedback 1326 (e.g., a HARQ ID that is common across UEs transmitting the command). In another example, the EH device ID can be used along with the source ID of the UE (e.g., the first UE 1304a) as an identifier of the resources configured to carry the feedback 1326 (e.g., from among the resources available to carry the feedback 1326).

Where the feedback 1326 indicates an ACK, e.g., such that the EH device 1306 indicates successful reception and demodulation of the command carried on the modulated wave 1322, the first UE 1304a may cease any further retransmissions of the command.

In some aspects, the second UE 1304b may transmit the feedback 1326 to the first UE 1304a. For example, the second UE 1304b may receive the feedback 1326 from the EH device 1306 (e.g., on a set of resources that the second UE 1304b is configured to monitor for the feedback 1326), and the second UE 1304b may inform the first UE 1304a of the content of the feedback 1326.

In some other aspects, the EH device 1306 may be configured to transmit the feedback 1326 on a set of resources that is commonly monitored by the UEs transmitting the command to the EH device 1306. In such other aspects, the first UE 1304a may receive the feedback 1326 from the EH device 1306 based on monitoring the common resources, and if the feedback 1326 indicates an ACK, the first UE 1304a may cease retransmissions of the command.

In still other aspects, the second UE 1304b may transmit the feedback 1326 to the network node 1302. The network node 1302 may inform the first UE 1304a of the feedback 1326, e.g., where the feedback 1326 indicates an ACK, which may instruct the first UE 1304a to cease transmission of the command. For example, the second UE 1304b may receive the feedback 1326 from the EH device 1306 (e.g., on a set of resources that the second UE 1304b is configured to monitor for the feedback 1326), and the second UE 1304b may inform the network node 1302 of the feedback 1326. Accordingly, the network node 1302 may transmit information indicating the feedback 1326 to each of the UEs that is transmitting the command to the EH device 1306, including the first UE 1304a.

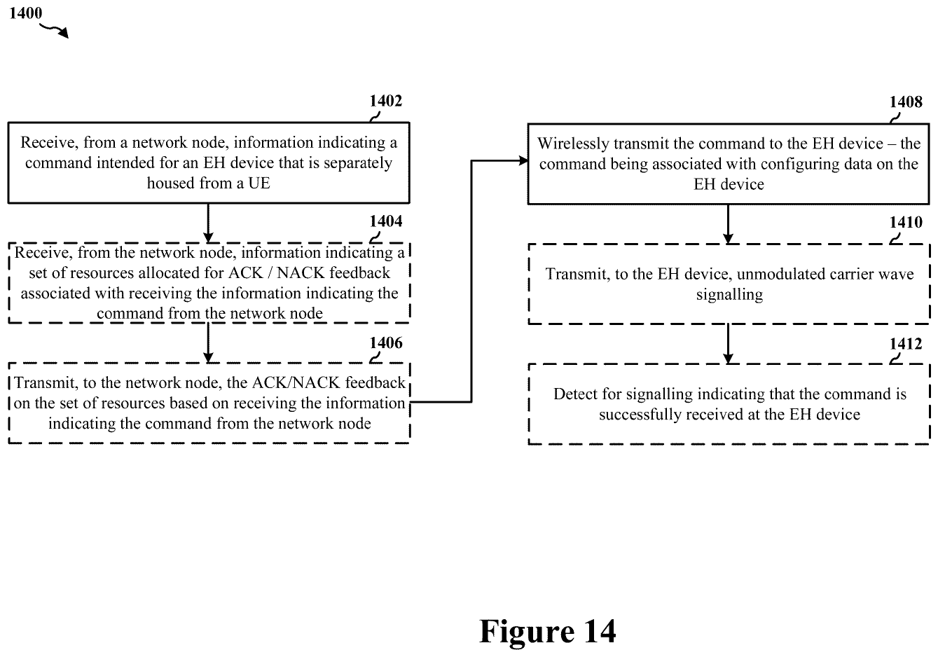

FIG. 14 is a flowchart illustrating an example of a method 1400 of wireless communication. The method 1400 may be performed by or at a UE (e.g., the UE 104, 450, 1004a, 1004b, 1004c, 1204a, 1204b, 1204c, 1304a, 1304b), another wireless communications apparatus (e.g., the apparatus 1702), or one or more components thereof. According to various different aspects, one or more of the illustrated blocks may be omitted, transposed, and/or contemporaneously performed.

At 1402, a UE may be configure to receive, from a network node, information indicating a command intended for a EH device that is separately housed from the UE. According to various aspects, the information indicating the command further indicates at least one of: a HARQ ID associated with the EH device, a class associated with the EH device, a category of an item associated with the EH device, at least one of data or control information with which the EH device is to be configured, a set of UEs associated with transmitting the command to the EH device, or a resource configuration associated with a link that is configured to carry the command to the EH device. In some aspects, the information indicating the command intended for the EH device is included in GC DCI. In some other aspects, the information indicating the command intended for the EH device is carried on a set of resources allocated on a groupcast short PDSCH scheduled by GC DCI.

For example, referring to FIG. 12, at least one of the UEs 1204a-1204c may be configured to receive, from the network node 1202, information indicating the command 1228 intended for the EH device 1206 that is separately housed from each of the UEs 1204a-1204c.

At 1404, the UE may be configured to receive, from the network node, information indicating a set of resources allocated for ACK/NACK feedback associated with receiving the information indicating the command from the network node. For example, referring to FIG. 12, at least one of the UEs 1204a-1204c may be configured to receive, from the network node 1202, information indicating a set of resources allocated for ACK/NACK feedback 1226 associated with receiving the information indicating the command 1228 from the network node 1202.

At 1406, the UE may be configured to transmit, to the network node, the ACK/NACK feedback on the set of resources based on receiving the information indicating the command from the network node. The ACK/NACK feedback may correspond to at least one of a HARQ ID, a source ID, or an EH device ID. In some aspects, the ACK/NACK feedback mechanism may be configured for NACK-only feedback. In such aspects, the UE may be configured to refrain from transmitting the ACK/NACK feedback when the information indicating the command is successfully received from the network node, and therefore, the ACK/NACK feedback may indicate a NACK when the information indicating the command is unsuccessfully received from the network node.

For example, referring to FIG. 12, at least one of the UEs 1204a-1204c may be configured to transmit, to the network node 1202, the feedback 1226 on a set of resources based on receiving the information indicating the command 1228 from the network node 1202.

At 1408, the UE may be configured to wirelessly transmit the command to the EH device. The command may be associated with configuring data on the EH device. In some aspects, the UE may be configured to select one set of resources on a link from a plurality of sets of resources indicated by a resource configuration from the network node based on a plurality of measured energies respectively corresponding to the plurality of sets of resources, and the command may be wirelessly transmitted to the EH device on the one set of resources.

For example, referring to FIG. 12, at least one of the UEs 1204a-1204c may be configured to wirelessly transmit the command 1228 to the EH device 1206. The command 1228 may be associated with configuring data on the EH device 1206. For example, referring to FIG. 13, the first UE 1304a may be configured to transmit the modulated wave 1322 to the EH device 1306.

At 1410, the UE may be configured to transmit, to the EH device, unmodulated carrier wave signalling. For example, referring to FIG. 13, the second UE 1304b may be configured to transmit the unmodulated wave 1324 to the EH device 1306.

At 1412, the UE may be configured to detect for signalling indicating that the command is successfully received at the EH device. For example, the signalling may indicate that the command is successfully received at the EH device via backscattered signalling of the unmodulated carrier wave signalling. In some aspects, the UE may be configured to transmit ACK feedback when the signalling indicates that the command is successfully received at the EH device. The ACK feedback may be transmitted to at least one of the network node or another UE. For example, referring to FIG. 13, the second UE 1304b may be configured to detect for signalling indicating that the modulated wave 1322 is successfully received at the EH device 1306.

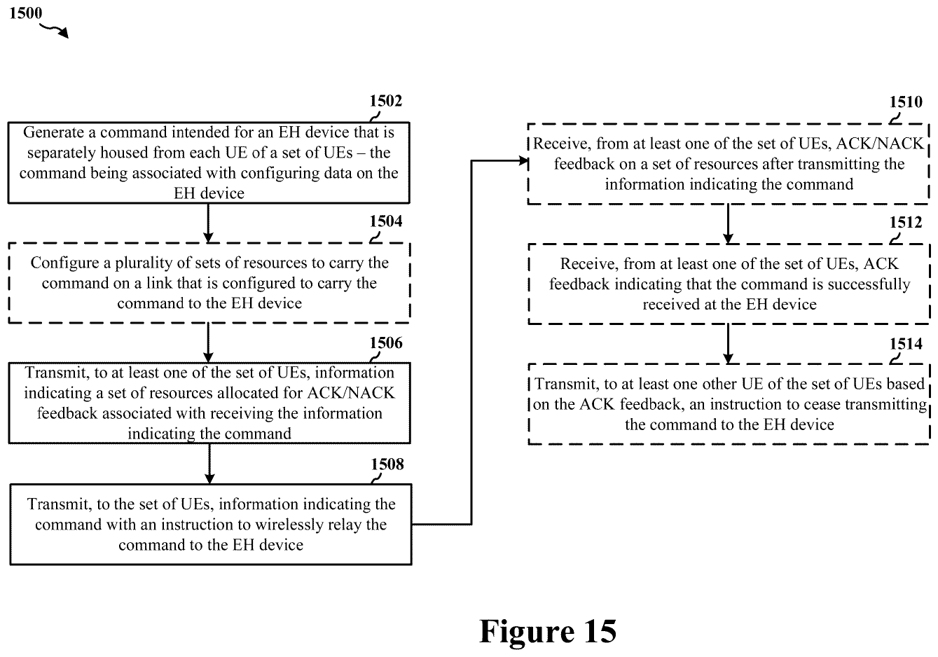

FIG. 15 is a flowchart illustrating an example of a method 1500 of wireless communication at a network node. The method 1500 may be performed by or at a base station or other network node (e.g., the base station 102/180, 410, the network node 1002, 1202, 1302), another wireless communications apparatus (e.g., the apparatus 1802), or one or more components thereof. According to various different aspects, one or more of the illustrated blocks may be omitted, transposed, and/or contemporaneously performed.

At 1502, the network node may be configured to generate a command intended for an EH device that is separately housed from each UE of a set of UEs. The command may be associated with configuring data on the EH device. According to various aspects, the information indicating the command further indicates at least one of: a HARQ ID associated with the EH device, a class associated with the EH device, a type of signal or information associated with the command, a priority associated with the command (e.g., a first priority that is relatively different from a second priority associated with another command), a latency condition associated with the command, a delay budget associated with the command, a reliability metric associated with the command (e.g., a block error rate, a packet error rate, a bit error rate, etc.), a category of an item associated with the EH device, at least one of data or control information with which the EH device is to be configured, a set of UEs associated with transmitting the command to the EH device, or a resource configuration associated with a link that is configured to carry the command to the EH device. In some aspects, the information indicating the command is included in GC DCI. In some other aspects, the information indicating the command is carried on a set of resources allocated on a groupcast short PDSCH scheduled by GC DCI.

For example, referring to FIG. 12, the network node 1202 may be configured to transmit, to the group of UEs 1204a-1204c, information indicating the command 1228 intended for the EH device 1206 that is separately housed from each of the UEs 1204a-1204c.

At 1504, the network node may be configured to configure a plurality of sets of resources to carry the command on a link that is configured to carry the command to the EH device. For example, referring to FIG. 12, the network node 1202 may be configured to configure a plurality of sets of resources to carry the command 1228 on a link between each of the group of UEs 1204a-1204c and the EH device 1206 that is separately housed from each of the UEs 1204a-1204c.

At 1506, the network node may be configured to transmit, to at least one of the set of UEs, information indicating a set of resources allocated for ACK/NACK feedback associated with receiving the information indicating the command.

For example, referring to FIG. 12, the network node 1202 may be configured to transmit, to at least one of the group of UEs 1204a-1204c, information indicating a set of resources allocated for ACK/NACK feedback 1226 associated with receiving the information indicating the command 1228.

At 1508, the network node may be configured to transmit, to the set of UEs, information indicating the command with an instruction to wirelessly relay the command to the EH device. For example, referring to FIG. 12, the network node 1202 may be configured to transmit, to the group of UEs 1204a-1204c, information indicating the command 1228 intended for the EH device 1206 with an instruction to wirelessly relay the command to the EH device 1206.

At 1510, the network node may be configured to receive, from at least one of the set of UEs, the ACK/NACK feedback on the set of resources after transmitting the information indicating the command. The ACK/NACK feedback may correspond to at least one of a HARQ ID, a source ID, or an EH device ID. In some aspects, the ACK/NACK feedback indicates a NACK when the information indicating the command is unsuccessfully received by the at least one of the set of UEs, and the ACK/NACK feedback is absent when the information indicating the command is successfully received by the at least one of the set of UEs.

At 1512, the network node may be configured to receive, from at least one of the set of UEs, ACK feedback indicating that the command is successfully received at the EH device. For example, referring to FIG. 13, the network node 1302 may be configured to receive, from the second UE 1304b, the feedback 1326 indicating that the modulated wave 1322 is successfully received at the EH device 1306.

At 1514, the network node may be configured to transmit, to at least one other UE of the set of UEs based on the ACK feedback, an instruction to cease transmitting the command to the EH device. For example, referring to FIG. 13, the network node 1302 may be configured to transmit, to the first UE 1304a, the feedback 1326 indicating that the modulated wave 1322 is successfully received at the EH device 1306.

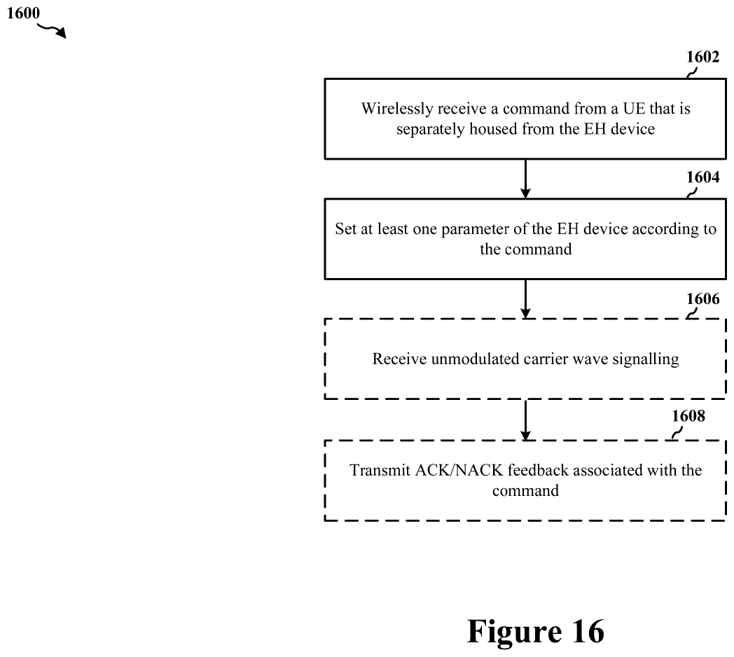

FIG. 16 is a flowchart illustrating an example of a method 1600 of wireless communication at an EH device. The method 1600 may be performed by or at an EH device (e.g., the EH device 106, 506, 600, 700, 906, 1006, 1106, 1206, 1306), another wireless communications apparatus (e.g., the apparatus 1902), or one or more components thereof. According to various different aspects, one or more of the illustrated blocks may be omitted, transposed, and/or contemporaneously performed.

At 1602, the EH device may be configured to wirelessly receive a command from a UE that is separately housed from the EH device. In some aspects, the command indicates at least one of: a HARQ ID associated with the EH device, a class associated with the EH device, a category of an item associated with the EH device, or at least one of data or control information with which the EH device is to be configured.

For example, referring to FIG. 12, the EH device 1206 may be configured to receive, from at least one of the UEs 1204a-1204c, the command 1228. The command 1228 may be associated with configuring data on the EH device 1206. For example, referring to FIG. 13, the EH device 1306 may be configured to receive, from the first UE 1304a, the modulated wave 1322 indicating the command.

At 1604, the EH device may be configured to set at least one parameter of the EH device according to the command. In some aspects, setting the at least one parameter of the EH device includes changing at least one value of the at least one parameter to at least one other value based on the data or control information. In some other aspects, setting the at least one parameter of the EH device includes at least one of adding or deleting at least one value of the at least one parameter based on the data or control information.

For example, referring to FIG. 12, the EH device 1206 may be configured to set at least one parameter of the EH device 1206 according to the command 1228. For example, referring to FIG. 13, the EH device 1306 may be configured to set at least one parameter of the EH device 1306 according to the command modulated onto the modulated wave 1322.

At 1606, the EH device may be configured to receive unmodulated carrier wave signalling. For example, referring to FIG. 13, the EH device 1306 may be configured to receive, from the second UE 1304b, the unmodulated wave 1324.

At 1608, the EH device may be configured to transmit ACK/NACK feedback associated with the command based on wirelessly receiving the command. In some aspects, the EH device may be configured to backscatter the unmodulated carrier wave signalling. In some aspects, the ACK/NACK feedback indicates an ACK when the command is successfully wirelessly received. In some aspects, the ACK/NACK feedback indicates a NACK when the command is unsuccessfully wirelessly received. For example, referring to FIG. 13, the EH device 1306 may be configured to transmit, to at least the second UE 1304b, the feedback 1326 associated with the command based on wirelessly receiving the command modulated onto the modulated wave 1322.

FIG. 17 is a diagram 1700 illustrating an example of a hardware implementation for an apparatus 1702. The apparatus 1702 may be a UE or similar device, or the apparatus 1702 may be a component of a UE or similar device. The apparatus 1702 may include a cellular baseband processor 1704 (also referred to as a modem) and/or a cellular RF transceiver 1722, which may be coupled together and/or integrated into the same package, component, circuit, chip, and/or other circuitry.

In some aspects, the apparatus 1702 may accept or may include one or more subscriber identity modules (SIM) cards 1720, which may include one or more integrated circuits, chips, or similar circuitry, and which may be removable or embedded. The one or more SIM cards 1720 may carry identification and/or authentication information, such as an international mobile subscriber identity (IMSI) and/or IMSI-related key(s). Further, the apparatus 1702 may include one or more of an application processor 1706 coupled to a secure digital (SD) card 1708 and a screen 1710, a Bluetooth module 1712, a wireless local area network (WLAN) module 1714, a Global Positioning System (GPS) module 1716, and/or a power supply 1718.

The cellular baseband processor 1704 communicates through the cellular RF transceiver 1722 with the UE 104, the EH device 106, and/or base station 102/180. The cellular baseband processor 1704 may include a computer-readable medium/memory. The computer-readable medium/memory may be non-transitory. The cellular baseband processor 1704 is responsible for general processing, including the execution of software stored on the computer-readable medium/memory. The software, when executed by the cellular baseband processor 1704, causes the cellular baseband processor 1704 to perform the various functions described supra. The computer-readable medium/memory may also be used for storing data that is manipulated by the cellular baseband processor 1704 when executing software. The cellular baseband processor 1704 further includes a reception component 1730, a communication manager 1732, and a transmission component 1734. The communication manager 1732 includes the one or more illustrated components. The components within the communication manager 1732 may be stored in the computer-readable medium/memory and/or configured as hardware within the cellular baseband processor 1704.

In the context of FIG. 4, the cellular baseband processor 1704 may be a component of the UE 450 and may include the memory 460 and/or at least one of the TX processor 468, the RX processor 456, and/or the controller/processor 459. In one configuration, the apparatus 1702 may be a modem chip and/or may be implemented as the baseband processor 1704, while in another configuration, the apparatus 1702 may be the entire UE (e.g., the UE 450 of FIG. 4) and may include some or all of the abovementioned components, circuits, chips, and/or other circuitry illustrated in the context of the apparatus 1702. In one configuration, the cellular RF transceiver 1722 may be implemented as at least one of the transmitter 454TX and/or the receiver 454RX.

The reception component 1730 may be configured to receive signaling on a wireless channel, such as signaling from a base station 102/180 or UE 104. The transmission component 1734 may be configured to transmit signaling on a wireless channel, such as signaling to a base station 102/180 or UE 104. The communication manager 1732 may coordinate or manage some or all wireless communications by the apparatus 1702, including across the reception component 1730 and the transmission component 1734.

The reception component 1730 may provide some or all data and/or control information included in received signaling to the communication manager 1732, and the communication manager 1732 may generate and provide some or all of the data and/or control information to be included in transmitted signaling to the transmission component 1734. The communication manager 1732 may include the various illustrated components, including one or more components configured to process received data and/or control information, and/or one or more components configured to generate data and/or control information for transmission.

The communication manager 1732 may include one or more of a command component 1740, an RFID communication component 1742, a selection component 1744, a feedback component 1746, and/or a detection component 1748.

The command component 1740 may be configured to receive, e.g., through the reception component 1730 and from the base station 102/180, information indicating a command intended for an EH device 106 that is separately housed from the apparatus 1702, e.g., as described in connection with 1402 of FIG. 14. According to various aspects, the information indicating the command further indicates at least one of: a HARQ ID associated with the EH device 106, a class associated with the EH device 106, a category of an item associated with the EH device 106, at least one of data or control information with which the EH device 106 is to be configured, a set of UEs associated with transmitting the command to the EH device 106, or a resource configuration associated with a link that is configured to carry the command to the EH device 106. In some aspects, the information indicating the command intended for the EH device 106 is included in GC DCI. In some other aspects, the information indicating the command intended for the EH device 106 is carried on a set of resources allocated on a groupcast short PDSCH scheduled by GC DCI.

The feedback component 1746 may be configured to receive, through the reception component 1730 and from the base station 102/180, information indicating a set of resources allocated for ACK/NACK feedback associated with receiving the information indicating the command from the base station 102/180, e.g., as described in connection with 1404 of FIG. 14.

The feedback component 1746 may be further configured to transmit, through the transmission component 1734 and to the base station 102/180, ACK/NACK feedback on a set of resources based on receiving the information indicating the command from the base station 102/180, e.g., as described in connection with 1406 of FIG. 14. The ACK/NACK feedback may correspond to at least one of a HARQ ID, a source ID, or an EH device 106 ID. In some aspects, the ACK/NACK feedback mechanism may be configured for NACK-only feedback. In such aspects, the feedback component 1746 may be configured to refrain from transmitting the ACK/NACK feedback when the information indicating the command is successfully received from the base station 102/180, and therefore, the ACK/NACK feedback may indicate a NACK when the information indicating the command is unsuccessfully received from the base station 102/180.

The RFID communication component 1742 may be configured to wirelessly transmit, through the transmission component 1734, the command to the EH device 106, e.g., as described in connection with 1408 of FIG. 14. The command may be associated with configuring data on the EH device 106. In some aspects, the selection component 1744 may be configured to select one set of resources on a link from a plurality of sets of resources indicated by a resource configuration from the base station 102/180 based on a plurality of measured energies respectively corresponding to the plurality of sets of resources, and the command may be wirelessly transmitted to the EH device 106 on the one set of resources.

The RFID communication component 1742 may be further configured to transmit, through the transmission component 1734 and to the EH device 106, unmodulated carrier wave signalling, e.g., as described in connection with 1410 of FIG. 14.

The detection component 1748 may be configured to detect for signalling indicating that the command is successfully received at the EH device 106, e.g., as described in connection with 1412 of FIG. 14. For example, the signalling may indicate that the command is successfully received at the EH device 106 via backscattered signalling of the unmodulated carrier wave signalling.

In some aspects, the feedback component 1746 may be further configured to transmit, through the transmission component 1734, ACK feedback when the signalling indicates that the command is successfully received at the EH device 106. The ACK feedback may be transmitted to at least one of the base station 102/180 or another UE 04.

The apparatus 1702 may include additional components that perform some or all of the blocks, operations, signaling, etc. of the algorithms in the aforementioned timing diagram of FIG. 11, call flow diagrams of FIGS. 12 and 13, and/or flowchart of FIG. 14. As such, some or all of the blocks, operations, signaling, etc. in the aforementioned timing diagram of FIG. 11, call flow diagrams of FIGS. 12 and 13, and/or flowchart of FIG. 14 may be performed by one or more components and the apparatus 1702 may include one or more such components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1702, and in particular the cellular baseband processor 1704, includes means for receiving, from a network node, information indicating a command intended for an EH device that is separately housed from the apparatus 1702; and means for wirelessly transmitting the command to the EH device, the command being associated with configuring data on the EH device.

In one configuration, the EH device includes one of an RFID tag, a ZP-IoT device, or another UE having an RFID tag radio.

In one configuration, the information indicating the command further indicates at least one of: a HARQ ID associated with the EH device, a class associated with the EH device, a category of an item associated with the EH device, at least one of data or control information with which the EH device is to be configured, a set of UEs associated with transmitting the command to the EH device, a type of signal or information associated with the command, a priority associated with the command, a latency condition associated with the command, a delay budget associated with the command, a reliability metric associated with the command, or a resource configuration associated with a link that is configured to carry the command to the EH device.

In one configuration, the apparatus 1702, and in particular the cellular baseband processor 1704, may further include means for selecting one set of resources on the link from a plurality of sets of resources indicated by the resource configuration based on a plurality of measured energies respectively corresponding to the plurality of sets of resources, and the command is wirelessly transmitted to the EH device on the one set of resources.

In one configuration, the information indicating the command intended for the EH device is at least one of included in group common DCI or carried on resources allocated on a groupcast short PDSCH scheduled by the group common DCI.

In one configuration, at least one of the group common DCI or the groupcast short PDSCH is scheduled on at least one CFR that is allocated to a group of UEs configured to communicate with the EH device.

In one configuration, the apparatus 1702, and in particular the cellular baseband processor 1704, may further include means for receiving, from the network node, information indicating a set of resources allocated for ACK/NACK feedback associated with receiving the information indicating the command from the network node; and means for transmitting, to the network node, the ACK/NACK feedback on the set of resources based on receiving the information indicating the command from the network node, and the ACK/NACK feedback corresponds to at least one of a HARQ ID, a source ID, or a RFID tag ID.

In one configuration, the apparatus 1702, and in particular the cellular baseband processor 1704, may further include means for refraining from transmitting the ACK/NACK feedback when the information indicating the command is successfully received from the network node, and the ACK/NACK feedback indicates a NACK when the information indicating the command is unsuccessfully received from the network node.

In one configuration, the apparatus 1702, and in particular the cellular baseband processor 1704, may further include means for detecting for signalling indicating that the command is successfully received at the EH device; and means for transmitting ACK feedback when the signalling indicates that the command is successfully received at the EH device.

In one configuration, the apparatus 1702, and in particular the cellular baseband processor 1704, may further include means for transmitting, to the EH device, unmodulated carrier wave signalling, and the signalling indicating that the command is successfully received at the EH device includes backscattered signalling of the unmodulated carrier wave signalling.

In one configuration, the ACK feedback is transmitted to at least one of the network node or another UE.

The aforementioned means may be one or more of the aforementioned components of the apparatus 1702 configured to perform the functions recited by the aforementioned means. As described supra, the apparatus 1702 may include the TX Processor 468, the RX Processor 456, and the controller/processor 459. As such, in one configuration, the aforementioned means may be the TX Processor 468, the RX Processor 456, and the controller/processor 459 configured to perform the functions recited by the aforementioned means.

FIG. 18 is a diagram 1800 illustrating an example of a hardware implementation for an apparatus 1802. The apparatus 1802 may be a network node (e.g., a base station) or similar device or system, or the apparatus 1802 may be a component of a network node or similar device or system. The apparatus 1802 may include a baseband unit 1804. The baseband unit 1804 may communicate through a cellular RF transceiver. For example, the baseband unit 1804 may communicate through a cellular RF transceiver with a UE 104, such as for downlink and/or uplink communication, and/or with a base station 102/180, such as for IAB.

The baseband unit 1804 may include a computer-readable medium/memory, which may be non-transitory. The baseband unit 1804 is responsible for general processing, including the execution of software stored on the computer-readable medium/memory. The software, when executed by the baseband unit 1804, causes the baseband unit 1804 to perform the various functions described supra. The computer-readable medium/memory may also be used for storing data that is manipulated by the baseband unit 1804 when executing software. The baseband unit 1804 further includes a reception component 1830, a communication manager 1832, and a transmission component 1834. The communication manager 1832 includes the one or more illustrated components. The components within the communication manager 1832 may be stored in the computer-readable medium/memory and/or configured as hardware within the baseband unit 1804. In the context of FIG. 4, the baseband unit 1804 may be a component of the base station 410 and may include the memory 476 and/or at least one of the TX processor 416, the RX processor 470, and the controller/processor 475.

The reception component 1830 may be configured to receive signaling on a wireless channel, such as signaling from a UE 104 or base station 102/180. The transmission component 1834 may be configured to transmit signaling on a wireless channel, such as signaling to a UE 104 or base station 102/180. The communication manager 1832 may coordinate or manage some or all wireless communications by the apparatus 1802, including across the reception component 1830 and the transmission component 1834.

The reception component 1830 may provide some or all data and/or control information included in received signaling to the communication manager 1832, and the communication manager 1832 may generate and provide some or all of the data and/or control information to be included in transmitted signaling to the transmission component 1834. The communication manager 1832 may include the various illustrated components, including one or more components configured to process received data and/or control information, and/or one or more components configured to generate data and/or control information for transmission. In some aspects, the generation of data and/or control information may include packetizing or otherwise reformatting data and/or control information received from a core network, such as the core network 190 or the EPC 160, for transmission.

The communication manager 1832 may include one or more of a generation component 1840, an RFID relay component 1842, a resource allocation component 1844, and/or a feedback component 1846.

The generation component 1840 may be configured to generate a command intended for an EH device 106 that is separately housed from each UE 104 of a set of UEs, e.g., as described in connection with 1502 of FIG. 15. The command may be associated with configuring data on the EH device 106. According to various aspects, the information indicating the command further indicates at least one of: a HARQ ID associated with the EH device 106, a class associated with the EH device 106, a category of an item associated with the EH device 106, at least one of data or control information with which the EH device 106 is to be configured, a set of UEs associated with transmitting the command to the EH device 106, or a resource configuration associated with a link that is configured to carry the command to the EH device 106. In some aspects, the information indicating the command is included in GC DCI. In some other aspects, the information indicating the command is carried on a set of resources allocated on a groupcast short PDSCH scheduled by GC DCI.

The resource allocation component 1844 may be configured to configure a plurality of sets of resources to carry the command on a link that is configured to carry the command to the EH device 106, e.g., as described in connection with 1504 of FIG. 15.

The resource allocation component 1844 may be further configured to transmit, through the transmission component 1834 and to at least one of the set of UEs, information indicating a set of resources allocated for ACK/NACK feedback associated with receiving the information indicating the command, e.g., as described in connection with 1506 of FIG. 15.

The RFID relay component 1842 may be configured to transmit, through the transmission component 1834 and to the set of UEs, information indicating the command with an instruction to wirelessly relay the command to the EH device 106, e.g., as described in connection with 1508 of FIG. 15.

The feedback component 1846 may be configured to receive, through the reception component 1830 and from at least one of the set of UEs, ACK/NACK feedback on the set of resources after transmitting the information indicating the command, e.g., as described in connection with 1510 of FIG. 15. The ACK/NACK feedback may correspond to at least one of a HARQ ID, a source ID, or an EH device 106 ID. In some aspects, the ACK/NACK feedback indicates a NACK when the information indicating the command is unsuccessfully received by the at least one of the set of UEs, and the ACK/NACK feedback is absent when the information indicating the command is successfully received by the at least one of the set of UEs.

The feedback component 1846 may be further configured to receive, through the reception component 1830 and from at least one of the set of UEs, ACK feedback indicating that the command is successfully received at the EH device 106, e.g., as described in connection with 1512 of FIG. 15.

The RFID relay component 1842 may be further configured to transmit, through the transmission component 1834 and to at least one other UE 104 of the set of UEs based on the ACK feedback, an instruction to cease transmitting the command to the EH device 106, e.g., as described in connection with 1514 of FIG. 15.

The apparatus 1802 may include additional components that perform some or all of the blocks, operations, signaling, etc. of the algorithm(s) in the aforementioned call flow diagrams of FIGS. 12 and 13 and/or flowchart of FIG. 15. As such, some or all of the blocks, operations, signaling, etc. in the aforementioned call flow diagrams of FIGS. 12 and 13 and/or flowchart of FIG. 15 may be performed by a component and the apparatus 1802 may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1802, and in particular the baseband unit 1804, includes means for generating a command intended for an EH device that is separately housed from each UE of a set of UEs, the command being associated with configuring data on the EH device; and means for transmitting, to the set of UEs, information indicating the command with an instruction to wirelessly relay the command to the EH device.

In one configuration, the EH device includes one of a RFID tag, a ZP-IoT device, or another UE having an RFID tag radio.

In one configuration, the information indicating the command further indicates at least one of: a HARQ ID associated with the EH device, a class associated with the EH device, a category of an item associated with the EH device, at least one of data or control information with which the EH device is to be configured, a set of UEs associated with transmitting the command to the EH device, a type of signal or information associated with the command, a priority associated with the command, a latency condition associated with the command, a delay budget associated with the command, a reliability metric associated with the command, or a resource configuration associated with a link that is configured to carry the command to the EH device.

In one configuration, the apparatus 1802, and in particular the baseband unit 1804, may further include means for configuring a plurality of sets of resources to carry the command on the link, and the plurality of sets of resources are indicated by the resource configuration.

In one configuration, the information indicating the command is at least one of included in group common DCI or carried on resources allocated on a groupcast short PDSCH scheduled by the group common DCI.

In one configuration, at least one of the group common DCI or the groupcast short PDSCH is scheduled on at least one CFR that is allocated to a group of UEs configured to communicate with the EH device.

In one configuration, the apparatus 1802, and in particular the baseband unit 1804, may further include means for transmitting, to at least one of the set of UEs, information indicating a set of resources allocated for ACK/NACK feedback associated with receiving the information indicating the command; and means for receiving, from at least one of the set of UEs, the ACK/NACK feedback on the set of resources after transmitting the information indicating the command, and the ACK/NACK feedback corresponds to at least one of a HARQ ID, a source ID, or a RFID tag ID.

In one configuration, the ACK/NACK feedback indicates a NACK when the information indicating the command is unsuccessfully received, and the ACK/NACK feedback is absent when the information indicating the command is successfully received.

In one configuration, the apparatus 1802, and in particular the baseband unit 1804, may further include means for receiving, from at least one of the set of UEs, ACK feedback indicating that the command is successfully received at the EH device.

In one configuration, the apparatus 1802, and in particular the baseband unit 1804, may further include means for transmitting, to at least one other UE of the set of UEs based on the ACK feedback, an instruction to cease transmitting the command to the EH device.

The aforementioned means may be one or more of the aforementioned components of the apparatus 1802 configured to perform the functions recited by the aforementioned means. As described supra, the apparatus 1802 may include the TX Processor 416, the RX Processor 470, and the controller/processor 475. As such, in one configuration, the aforementioned means may be the TX Processor 416, the RX Processor 470, and the controller/processor 475 configured to perform the functions recited by the aforementioned means.

FIG. 19 is a diagram 1900 illustrating an example of a hardware implementation for an apparatus 1902. The apparatus 1902 may be an EH device or similar device or system, or the apparatus 1902 may be a component of an EH device or similar device or system. The apparatus 1902 may include a processing unit 1904. The processing unit 1904 may communicate through a front end 1906. For example, the processing unit 1904 may communicate through the front end 1906 with a UE 104.

The processing unit 1904 may include a computer-readable medium/memory, which may be non-transitory. The processing unit 1904 is responsible for general processing, including the execution of software stored on the computer-readable medium/memory. The software, when executed by the processing unit 1904, causes the processing unit 1904 to perform the various functions described supra. The computer-readable medium/memory may also be used for storing data that is manipulated by the processing unit 1904 when executing software. The processing unit 1904 further includes a reception component 1930, a communication manager 1932, and a transmission component 1934. The communication manager 1932 includes the one or more illustrated components. The components within the communication manager 1932 may be stored in the computer-readable medium/memory and/or configured as hardware within the processing unit 1904.

The processing unit 1904 may be a component of the EH device 700 and may include the rectifier 710, the envelope detector 712, the logic 714, and/or the memory 716 configured to perform aspects described in the present disclosure related to an EH device.

The reception component 1930 may be configured to receive signaling on a wireless channel, such as signaling from a UE 104. The transmission component 1934 may be configured to transmit signaling on a wireless channel, such as signaling to a UE 104. The communication manager 1932 may coordinate or manage some or all wireless communications by the apparatus 1902, including across the reception component 1930 and the transmission component 1934.

The reception component 1930 may provide some or all data and/or control information included in received signaling to the communication manager 1932, and the communication manager 1932 may generate and provide some or all of the data and/or control information to be included in transmitted signaling to the transmission component 1934. The communication manager 1932 may include the various illustrated components, including one or more components configured to process received data and/or control information, and/or one or more components configured to generate data and/or control information for transmission. In some aspects, the generation of data and/or control information may include packetizing or otherwise reformatting data and/or control information for transmission.

The communication manager 1932 may include one or more of a command component 1940, a parameter component 1942, and/or a feedback component 1944.

The command component 1940 may be configured to wirelessly receive, through the reception component 1930, a command from a UE 104 that is separately housed from the apparatus 1902, e.g., as described in connection with 1602 of FIG. 16. In some aspects, the command indicates at least one of: a HARQ ID associated with the apparatus 1902, a class associated with the apparatus 1902, a category of an item associated with the apparatus 1902, or at least one of data or control information with which the apparatus 1902 is to be configured.

The parameter component 1942 may be configured to set at least one parameter of the apparatus 1902 according to the command, e.g., as described in connection with 1604 of FIG. 16. In some aspects, setting the at least one parameter of the apparatus 1902 includes changing at least one value of the at least one parameter to at least one other value based on the data or control information. In some other aspects, setting the at least one parameter includes at least one of adding or deleting at least one value of the at least one parameter based on the data or control information.

The feedback component 1944 may be configured to receive, through the reception component 1930, unmodulated carrier wave signalling, e.g., as described in connection with 1606 of FIG. 16.

The feedback component 1944 may be further configured to transmit, through the transmission component 1934, ACK/NACK feedback associated with the command based on wirelessly receiving the command, e.g., as described in connection with 1608 of FIG. 16. In some aspects, the feedback component 1944 may be configured to backscatter the unmodulated carrier wave signalling. In some aspects, the ACK/NACK feedback indicates an ACK when the command is successfully wirelessly received. In some aspects, the ACK/NACK feedback indicates a NACK when the command is unsuccessfully wirelessly received

In one configuration, the apparatus 1902, and in particular the processing unit 1904, includes means for wirelessly receiving a command from a UE that is separately housed from the apparatus 1902; and means for setting at least one parameter of the apparatus 1902 according to the command.

In one configuration, the command indicates at least one of: a HARQ ID associated with the apparatus 1902, a class associated with the apparatus 1902, a category of an item associated with the apparatus 1902, a type of signal or information associated with the command, a priority associated with the command, a latency condition associated with the command, a delay budget associated with the command, a reliability metric associated with the command, or at least one of data or control information with which the apparatus 1902 is to be configured.

In one configuration, the means for setting the at least one parameter of the apparatus 1902 is configured to change at least one value of the at least one parameter to at least one other value based on the data or control information.

In one configuration, the means for setting the at least one parameter of the apparatus 1902 is configured to at least one of add or delete at least one value of the at least one parameter based on the data or control information.

In one configuration, the apparatus 1902, and in particular the processing unit 1904, may further include means for transmitting ACK/NACK feedback associated with the command based on wirelessly receiving the command.

In one configuration, the ACK/NACK feedback indicates an ACK when the command is successfully wirelessly received.

In one configuration, the ACK/NACK feedback indicates a NACK when the command is unsuccessfully wirelessly received.

In one configuration, the apparatus 1902, and in particular the processing unit 1904, may further include means for receiving unmodulated carrier wave signalling, and the apparatus 1902 is configured to backscatter the unmodulated carrier wave signalling.

In one configuration, the apparatus 1902 includes one of an RFID tag, a ZP-IoT device, or another UE having an RFID tag radio.

The aforementioned means may be one or more of the aforementioned components of the apparatus 1902 configured to perform the functions recited by the aforementioned means. As described supra, the apparatus 1902 may include the rectifier 710, the envelope detector 712, the logic 714, and/or the memory 716. As such, in one configuration, the aforementioned means may be the rectifier 710, the envelope detector 712, the logic 714, and/or the memory 716 configured to perform the functions recited by the aforementioned means.

The specific order or hierarchy of blocks or operations in each of the foregoing processes, flowcharts, and other diagrams disclosed herein is an illustration of example approaches. Based upon design preferences, the specific order or hierarchy of blocks or operations in each of the processes, flowcharts, and other diagrams may be rearranged, omitted, and/or contemporaneously performed without departing from the scope of the present disclosure. Further, some blocks or operations may be combined or omitted. The accompanying method claims present elements of the various blocks or operations in a sample order, and are not meant to be limited to the specific order or hierarchy presented.

The following examples are illustrative only and may be combined with aspects of other embodiments or teachings described herein, without limitation.

Example 1 is an apparatus at a UE. The apparatus may include a memory and at least one processor coupled to the memory and configured to: receive, from a network node, information indicating a command intended for an EH device that is separately housed from the UE; and wirelessly transmit the command to the EH device, the command being associated with configuring data on the EH device.

Example 2 may include the apparatus of Example 1, and the EH device includes one of an RFID tag, a ZP-IoT device, or another UE having an RFID tag radio.

Example 3 may include the apparatus of Example 1, and the information indicating the command further indicates at least one of: a HARQ ID associated with the EH device, a class associated with the EH device, a category of an item associated with the EH device, at least one of data or control information with which the EH device is to be configured, a set of UEs associated with transmitting the command to the EH device, a type of signal or information associated with the command, a priority associated with the command, a latency condition associated with the command, a delay budget associated with the command, a reliability metric associated with the command, or a resource configuration associated with a link that is configured to carry the command to the EH device.

Example 4 may include the apparatus of Example 3, and the at least one processor may be further configured to: select one set of resources on the link from a plurality of sets of resources indicated by the resource configuration based on a plurality of measured energies respectively corresponding to the plurality of sets of resources, and the command is wirelessly transmitted to the EH device on the one set of resources.

Example 5 may include the apparatus of Example 1, and the information indicating the command intended for the EH device is at least one of included in group common DCI or carried on resources allocated on a groupcast short PDSCH scheduled by the group common DCI.

Example 6 may include the apparatus of Example 5, and at least one of the group common DCI or the groupcast short PDSCH is scheduled on at least one CFR that is allocated to a group of UEs configured to communicate with the EH device.

Example 7 may include the apparatus of Example 1, and the at least one processor may be further configured to: receive, from the network node, information indicating a set of resources allocated for ACK/NACK feedback associated with receiving the information indicating the command from the network node; and transmit, to the network node, the ACK/NACK feedback on the set of resources based on receiving the information indicating the command from the network node, and the ACK/NACK feedback corresponds to at least one of a HARQ ID, a source ID, or a RFID tag ID.

Example 8 may include the apparatus of Example 7, and the at least one processor may be further configured to: refrain from transmitting the ACK/NACK feedback when the information indicating the command is successfully received from the network node, and the ACK/NACK feedback indicates a NACK when the information indicating the command is unsuccessfully received from the network node.

Example 9 may include the apparatus of Example 1, and the at least one processor may be further configured to: detect for signalling indicating that the command is successfully received at the EH device; and transmit ACK feedback when the signalling indicates that the command is successfully received at the EH device.

Example 10 may include the apparatus of Example 9, and the at least one processor may be further configured to: transmit, to the EH device, unmodulated carrier wave signalling, and the signalling indicating that the command is successfully received at the EH device includes backscattered signalling of the unmodulated carrier wave signalling.

Example 11 may include the apparatus of Example 9, and the ACK feedback is transmitted to at least one of the network node or another UE.

Example 12 is an apparatus at a network node. The apparatus may include a memory and at least one processor coupled to the memory and configured to: generate a command intended for an EH device that is separately housed from each UE of a set of UEs, the command being associated with configuring data on the EH device; and transmit, to the set of UEs, information indicating the command with an instruction to wirelessly relay the command to the EH device.

Example 13 may include the apparatus of Example 12, and the EH device includes one of a RFID tag, a ZP-IoT device, or another UE having an RFID tag radio.

Example 14 may include the apparatus of Example 12, and the information indicating the command further indicates at least one of: a HARQ ID associated with the EH device, a class associated with the EH device, a category of an item associated with the EH device, at least one of data or control information with which the EH device is to be configured, a set of UEs associated with transmitting the command to the EH device, a type of signal or information associated with the command, a priority associated with the command, a latency condition associated with the command, a delay budget associated with the command, a reliability metric associated with the command, or a resource configuration associated with a link that is configured to carry the command to the EH device.

Example 15 may include the apparatus of Example 14, and the at least one processor may be further configured to: configure a plurality of sets of resources to carry the command on the link, and the plurality of sets of resources are indicated by the resource configuration.

Example 16 may include the apparatus of Example 12, and the information indicating the command is at least one of included in group common DCI or carried on resources allocated on a groupcast short PDSCH scheduled by the group common DCI.

Example 17 may include the apparatus of Example 16, and at least one of the group common DCI or the groupcast short PDSCH is scheduled on at least one CFR that is allocated to a group of UEs configured to communicate with the EH device.

Example 18 may include the apparatus of Example 12, and the at least one processor may be further configured to: transmit, to at least one of the set of UEs, information indicating a set of resources allocated for ACK/NACK feedback associated with receiving the information indicating the command; and receive, from at least one of the set of UEs, the ACK/NACK feedback on the set of resources after transmitting the information indicating the command, and the ACK/NACK feedback corresponds to at least one of a HARQ ID, a source ID, or a RFID tag ID.

Example 19 may include the apparatus of Example 18, and the ACK/NACK feedback indicates a NACK when the information indicating the command is unsuccessfully received, and the ACK/NACK feedback is absent when the information indicating the command is successfully received.

Example 20 may include the apparatus of Example 12, and the at least one processor may be further configured to: receive, from at least one of the set of UEs, ACK feedback indicating that the command is successfully received at the EH device.

Example 21 may include the apparatus of Example 20, and the at least one processor may be further configured to: transmit, to at least one other UE of the set of UEs based on the ACK feedback, an instruction to cease transmitting the command to the EH device.

Example 22 is an apparatus at an EH device. The apparatus may include a memory and at least one processor coupled to the memory and configured to: wirelessly receive a command from a UE that is separately housed from the EH device; and set at least one parameter of the EH device according to the command.

Example 23 may include the apparatus of Example 22, and the command indicates at least one of: a HARQ ID associated with the EH device, a class associated with the EH device, a category of an item associated with the EH device, a type of signal or information associated with the command, a priority associated with the command, a latency condition associated with the command, a delay budget associated with the command, a reliability metric associated with the command, or at least one of data or control information with which the EH device is to be configured.

Example 24 may include the apparatus of Example 23, and to set the at least one parameter of the EH device, the at least one processor may be further configured to: change at least one value of the at least one parameter to at least one other value based on the data or control information.

Example 25 may include the apparatus of Example 23, and to set the at least one parameter of the EH device, the at least one processor may be further configured to: add or delete at least one value of the at least one parameter based on the data or control information.

Example 26 may include the apparatus of Example 22, and the at least one processor may be further configured to: transmit ACK/NACK feedback associated with the command based on wirelessly receiving the command.

Example 27 may include the apparatus of Example 26, and the ACK/NACK feedback indicates an ACK when the command is successfully wirelessly received.

Example 28 may include the apparatus of Example 26, and the ACK/NACK feedback indicates a NACK when the command is unsuccessfully wirelessly received.

Example 29 may include the apparatus of Example 22, and the at least one processor may be further configured to: receive unmodulated carrier wave signalling, and the EH device is configured to backscatter the unmodulated carrier wave signalling.

Example 30 may include the apparatus of Example 22, and the EH device includes one of a RFID tag, a ZP-IoT device, or another UE having an RFID tag radio.

The previous description is provided to enable one of ordinary skill in the art to practice the various aspects described herein. Various modifications to these aspects will be readily apparent to those having ordinary skill in the art, and the generic principles defined herein may be applied to other aspects. Thus, the claims are not intended to be limited to the aspects shown herein, but is to be accorded the full scope consistent with the language. Thus, the language employed herein is not intended to limit the scope of the claims to only those aspects shown herein, but is to be accorded the full scope consistent with the language of the claims.

As one example, the language “determining” may encompass a wide variety of actions, and so may not be limited to the concepts and aspects explicitly described or illustrated by the present disclosure. In some contexts, “determining” may include calculating, computing, processing, measuring, deriving, investigating, looking up (e.g., looking up in a table, a database or another data structure), ascertaining, resolving, selecting, choosing, establishing, and so forth. In some other contexts, “determining” may include communication and/or memory operations/procedures through which information or value(s) are acquired, such as “receiving” (e.g., receiving information), “accessing” (e.g., accessing data in a memory), “detecting,” and the like.

As another example, reference to an element in the singular is not intended to mean “one and only one” unless specifically stated, but rather “one or more.” Further, terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action or event, but rather imply that if a condition is met then another action or event will occur, but without requiring a specific or immediate time constraint or direct correlation for the other action or event to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of wireless communication at a user equipment (UE), comprising:
receiving, from a network node, information indicating a command intended for an energy harvesting (EH) device that is separately housed from the UE; and
wirelessly transmitting the command to the EH device, the command being associated with configuring data on the EH device.

2. The method of claim 1, wherein the EH device comprises one of a radio-frequency identification (RFID) tag, a zero-power (ZP) Internet of Things (IoT) device, or another UE having an RFID tag radio.

3. The method of claim 1, wherein the information indicating the command further indicates at least one of:
a hybrid automatic repeat request (HARQ) identifier (ID) associated with the EH device, a class associated with the EH device,
a category of an item associated with the EH device,
at least one of data or control information with which the EH device is to be configured,
a set of UEs associated with transmitting the command to the EH device,
a type of signal or information associated with the command,
a priority associated with the command,
a latency condition associated with the command,
a delay budget associated with the command,
a reliability metric associated with the command, or
a resource configuration associated with a link that is configured to carry the command to the EH device.

4. The method of claim 3, further comprising:
selecting one set of resources on the link from a plurality of sets of resources indicated by the resource configuration based on a plurality of measured energies respectively corresponding to the plurality of sets of resources, wherein the command is wirelessly transmitted to the EH device on the one set of resources.

5. The method of claim 1, wherein the information indicating the command intended for the EH device is at least one of included in group common downlink control information (DCI) or carried on resources allocated on a groupcast short physical downlink shared channel (PDSCH) scheduled by the group common DCI.

6. The method of claim 5, wherein at least one of the group common DCI or the groupcast short PDSCH is scheduled on at least one common frequency resource (CFR) that is allocated to a group of UEs configured to communicate with the EH device.

7. The method of claim 1, further comprising:
receiving, from the network node, information indicating a set of resources allocated for acknowledgement (ACK)/non-ACK (NACK) feedback associated with receiving the information indicating the command from the network node; and
transmitting, to the network node, the ACK/NACK feedback on the set of resources based on receiving the information indicating the command from the network node, wherein the ACK/NACK feedback corresponds to at least one of a hybrid automatic repeat request (HARQ) identifier (ID), a source ID, or a radio frequency identification (RFID) tag ID.

8. (canceled)

9. The method of claim 1, further comprising:
detecting for signalling indicating that the command is successfully received at the EH device; and
transmitting acknowledgement (ACK) feedback when the signalling indicates that the command is successfully received at the EH device.

10. The method of claim 9, further comprising:
transmitting, to the EH device, unmodulated carrier wave signalling, wherein the signalling indicating that the command is successfully received at the EH device comprises backscattered signalling of the unmodulated carrier wave signalling.

11. The method of claim 9, wherein the ACK feedback is transmitted to at least one of the network node or another UE.

12. A method of wireless communication at a network node, comprising:
generating a command intended for an energy harvesting (EH) device that is separately housed from each user equipment (UE) of a set of UEs, the command being associated with configuring data on the EH device; and
transmitting, to the set of UEs, information indicating the command with an instruction to wirelessly relay the command to the EH device.

13. The method of claim 12, wherein the EH device comprises one of a radio-frequency identification (RFID) tag, a zero-power (ZP) Internet of Things (IoT) device, or another UE having an RFID tag radio.

14. The method of claim 12, wherein the information indicating the command further indicates at least one of:
a hybrid automatic repeat request (HARQ) identifier (ID) associated with the EH device,
a class associated with the EH device,
a category of an item associated with the EH device,
at least one of data or control information with which the EH device is to be configured,
a set of UEs associated with transmitting the command to the EH device,
a type of signal or information associated with the command,
a priority associated with the command,
a latency condition associated with the command,
a delay budget associated with the command,
a reliability metric associated with the command, or
a resource configuration associated with a link that is configured to carry the command to the EH device.

15. The method of claim 14, further comprising:
configuring a plurality of sets of resources to carry the command on the link, wherein the plurality of sets of resources are indicated by the resource configuration.

16. The method of claim 12, wherein the information indicating the command is at least one of included in group common downlink control information (DCI) or carried on resources allocated on a groupcast short physical downlink shared channel (PDSCH) scheduled by the group common DCI.

17. (canceled)

18. The method of claim 12, further comprising:
transmitting, to at least one of the set of UEs, information indicating a set of resources allocated for acknowledgement (ACK)/non-ACK (NACK) feedback associated with receiving the information indicating the command; and
receiving, from at least one of the set of UEs, the ACK/NACK feedback on the set of resources after transmitting the information indicating the command, wherein the ACK/NACK feedback corresponds to at least one of a hybrid automatic repeat request (HARQ) identifier (ID), a source ID, or a radio frequency identification (RFID) tag ID.

19. The method of claim 18, wherein the ACK/NACK feedback indicates a NACK when the information indicating the command is unsuccessfully received, and the ACK/NACK feedback is absent when the information indicating the command is successfully received.

20. The method of claim 12, further comprising:
receiving, from at least one of the set of UEs, acknowledgement (ACK) feedback indicating that the command is successfully received at the EH device.

21. (canceled)

22. A method of wireless communication at an energy harvesting (EH) device, comprising:
wirelessly receiving a command from a user equipment (UE) that is separately housed from the EH device; and
setting at least one parameter of the EH device according to the command.

23. The method of claim 22, wherein the command indicates at least one of:
a hybrid automatic repeat request (HARQ) identifier (ID) associated with the EH device,
a class associated with the EH device,
a category of an item associated with the EH device,
a type of signal or information associated with the command,
a priority associated with the command,
a latency condition associated with the command,
a delay budget associated with the command,
a reliability metric associated with the command, or
at least one of data or control information with which the EH device is to be configured.

24-30. (canceled)
